(19) United States
(12) Patent Application Publication
(10) Pub. No.: US 2025/0060593 A1
(43) Pub. Date: Feb. 20, 2025

(54) VIRTUAL IMAGE DISPLAY DEVICE AND OPTICAL UNIT

(71) Applicant: SEIKO EPSON CORPORATION, Tokyo (JP)

(72) Inventor: Mitsutaka IDE, SHIOJIRI-SHI (JP)

(73) Assignee: SEIKO EPSON CORPORATION, Tokyo (JP)

(21) Appl. No.: 18/801,865

(22) Filed: Aug. 13, 2024

(30) Foreign Application Priority Data
Aug. 15, 2023 (JP) 2023-132193

(51) Int. Cl. G02B 27/01

(52) U.S. Cl. CPC G02B 27/0172

(57) ABSTRACT

A virtual image display device that includes a display element, a first lens on which the image light from the display element is incident, a first prism on which the image light passing through the first lens is incident, a second prism joined to the first prism, an oblique mirror portion provided at a joint between the first prism and the second prism, a plano-convex second lens disposed facing an outer surface of the first prism, a transmission mirror formed at a convex surface of the second lens, a first quarter-wave plate disposed between the outer surface of the first prism and the second lens, a compensation lens including a concave surface, a condensing reflection mirror disposed in the second prism, and a second quarter-wave plate disposed between the inner surface of the second prism and the condensing reflection mirror.

The present application is based on, and claims priority from JP Application Serial Number 2023-132193, filed Aug. 15, 2023, the disclosure of which is hereby incorporated by reference herein in its entirety.

### BACKGROUND

### 1. Technical Field

The present disclosure relates to a virtual image display device of a see-through type and an optical unit that enable observation of a virtual image.

### 2. Related Art

A head-mounted display has been known that includes a display device, a projection optical member, a prism member, and a light condensing reflective surface, wherein image light from the projection optical member is incident on a first prism of the prism member, totally reflected by an outer surface, partially reflected by a semi-transmissive reflective surface formed at a boundary between the first prism and a second prism of the prism member, then transmitted through the outer surface of the prism member, reflected by the light condensing reflective surface, returned to the prism member, transmitted through the semi-transmissive reflective surface, and further transmitted through an inner surface facing a pupil (see JP 2020-08749 A).

In the head-mounted display described above, since two reflection members are present in front of eyes, a luminance of the image light reaching an exit pupil is lower as compared to a case where the total number of reflecting members is one.

### SUMMARY

A virtual image display device in an aspect of the present disclosure is a virtual image display device of a direct virtual image type that includes a display element configured to emit image light, a first lens on which the image light from the display element is incident, a first prism on which the image light passing through the first lens is incident, a second prism joined to the first prism and configured to form a parallel flat plate-shaped prism light guide member, an oblique mirror portion provided at a joint between the first prism and the second prism and configured to reflect a first part of the image light guided in the first prism, a plano-convex second lens disposed facing an outer surface of the first prism on which the first part of the image light reflected by the oblique mirror portion is incident, a transmission mirror formed at a convex surface of the second lens and configured to reflect a part of the image light reflected by the oblique mirror portion toward the oblique mirror portion, a first quarter-wave plate disposed between the outer surface of the first prism and the second lens, a compensation lens including a concave surface joined to the convex surface of the second lens via the transmission mirror, and a surface parallel to the outer surface of the first prism, a condensing reflection mirror disposed in the second prism and configured to reflect a second part of the image light transmitted through the oblique mirror portion and reflected by an inner surface of the second prism, and a second quarter-wave plate disposed between the inner surface of the second prism and the condensing reflection mirror.

An optical unit in an aspect of the present disclosure is an optical unit of a direct virtual image type that includes a first lens on which image light from a display element for emitting the image light is incident, a first prism on which the image light passing through the first lens is incident, a second prism joined to the first prism and configured to form a parallel flat plate-shaped prism light guide member, an oblique mirror portion provided at a joint between the first prism and the second prism and configured to reflect a first part of the image light guided in the first prism, a plano-convex second lens disposed facing an outer surface of the first prism on which the first part of the image light reflected by the oblique mirror portion is incident, a transmission mirror formed at a convex surface of the second lens and configured to reflect a part of the image light reflected by the oblique mirror portion toward the oblique mirror portion, a first quarter-wave plate disposed between the outer surface of the first prism and the second lens, a compensation lens including a concave surface joined to the convex surface of the second lens via the transmission mirror, and a surface parallel to the outer surface of the first prism, a condensing reflection mirror disposed in the second prism and configured to reflect a second part of the image light transmitted through the oblique mirror portion and reflected by an inner surface of the second prism, and a second quarter-wave plate disposed between the inner surface of the second prism and the condensing reflection mirror.

### BRIEF DESCRIPTION OF THE DRAWINGS

FIG. 1 is an external view for explaining a usage state of a virtual image display device of a first embodiment.

FIG. 2 is a side cross-sectional view for explaining an internal structure of a display device on one side.

FIG. 3 is a conceptual perspective view for explaining a first display unit.

FIG. 4 is a perspective view for explaining an external structure of the first display unit.

FIG. 5 is a diagram for explaining shapes and the like of a first image forming element and a first lens.

FIG. 6 is a side cross-sectional view for explaining an internal optical path of the display device on the one side.

FIG. 7 is a side cross-sectional view for explaining a state in which image light emitted from a specific region of a display element is incident on an exit pupil in the display device on the one side.

FIG. 8 is a side cross-sectional view for explaining a state in which the image light emitted from a specific region of the display element is incident on the exit pupil in the display device on the one side.

FIG. 9 is a side cross-sectional view for explaining a state in which the image light emitted from a specific region of the display element is incident on the exit pupil in the display device on the one side.

FIG. 10 is a diagram in which FIG. 7, FIG. 8, and FIG. 9 are superimposed.

FIG. 11 is a diagram for explaining a result of computer simulation relating to a ray angle of partial image light illustrated in FIG. 10.

FIG. 12 is a diagram for explaining trial calculation of a utilization efficiency of the image light and a see-through transmittance in the first embodiment.

FIG. 13 is a diagram for explaining an example of a structure of a prism light guide member.

FIG. 14 is a diagram for explaining an example of assembly of the prism light guide member.

FIG. 15 is a perspective view for explaining an example of a structure and assembly of the first display unit.

FIG. 16 is a side cross-sectional view for explaining an internal structure of a display device on one side according to a second embodiment.

FIG. 17 is a side cross-sectional view for explaining another internal structure of the display device on the one side according to the second embodiment.

FIG. 18 is a diagram illustrating an optical path of stray light.

FIG. 19 is a diagram illustrating an observation direction of a condensing reflection mirror.

FIG. 20 is a diagram for explaining a structure in which the condensing reflection mirror is divided into a plurality of partial reflection surfaces.

FIG. 21 is a side cross-sectional view illustrating a configuration of a second lens formed of a plurality of materials.

FIG. 22 is a side cross-sectional view illustrating differences in optical paths entering the second lens.

### DESCRIPTION OF EMBODIMENTS

### First Embodiment

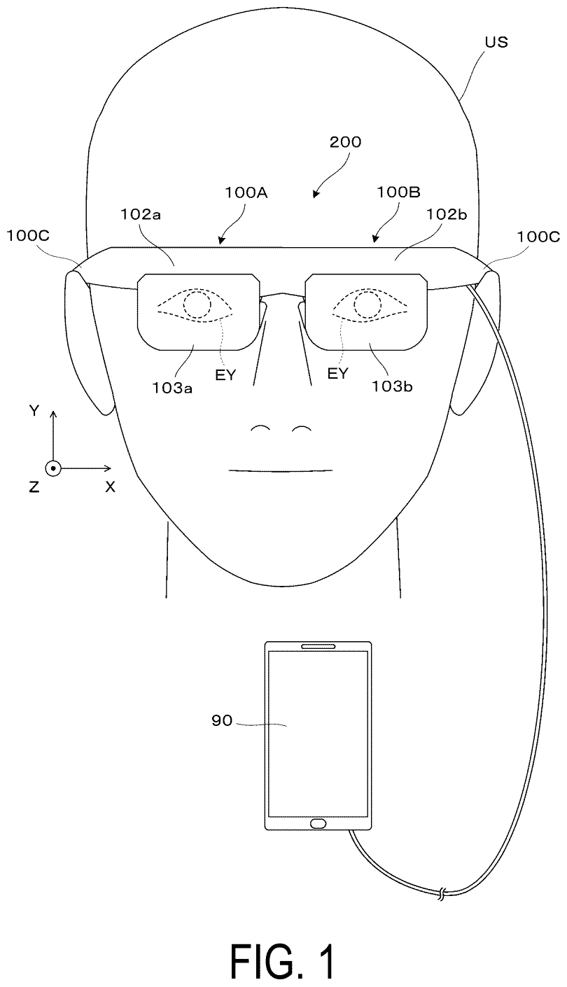

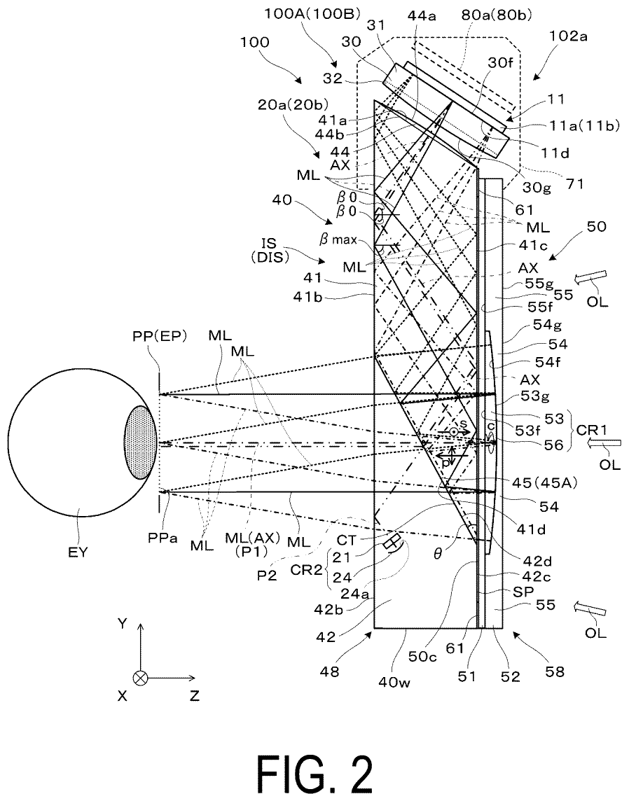

A first embodiment of a virtual image display device and the like according to the present disclosure will be described below with reference to FIGS. 1, 2 and the like.

FIG. 1 is a diagram for explaining a mounted state of a head-mounted virtual image display device (hereinafter, also referred to as a head-mounted display or an “HMD”) 200, and the HMD 200 allows an observer or wearer US who is wearing the HMD 200 to recognize an image as a virtual image. In FIG. 1 or the like, X, Y, and Z represent a rectangular coordinate system. A +X direction corresponds to a lateral direction in which both eyes EY of the observer or the wearer US who wears the HMD 200 are arranged. A +Y direction corresponds to an upper direction perpendicular to the lateral direction from the viewpoint of the wearer US in which both eyes EY are arranged. A +Z direction corresponds to a forward direction or a front side direction from the viewpoint of the wearer US. +Y directions are parallel to a vertical axis or a vertical direction.

The HMD 200 includes a first virtual image display device 100A for a right eye and of a direct virtual image type, a second virtual image display device 100B for a left eye and of a direct virtual image type, a pair of temple type support devices 100C that support the virtual image display devices 100A and 100B, and a user terminal 90 as an information terminal. The first virtual image display device 100A alone functions as the HMD, and includes a first display driving unit 102a disposed at an upper portion, and a first combiner 103a having a shape of a spectacle lens and covering the front of an eye. Similarly, the second virtual image display device 100B alone functions as the HMD, and includes a second display driving unit 102b disposed at the upper portion, and a second combiner 103b having a shape of a spectacle lens and covering the front of an eye. The support devices 100C are mounting members mounted on a head of the wearer US, and support upper end sides of the pair of combiners 103a and 103b via the display driving units 102a and 102b that are integrated in appearance. The first virtual image display device 100A and the second virtual image display device 100B are optically identical or left-right inverted, and detailed description of the second virtual image display device 100B will be omitted.

FIG. 2 is a side cross-sectional view for explaining an internal structure of the first virtual image display device 100A. The first virtual image display device 100A includes a first image forming element 11a, a first display unit 20a, and a circuit member 80a. The first image forming element 11a is also referred to as a display element 11. The first display unit 20a is an imaging optical system IS that directly forms a virtual image without forming an intermediate image, and is also referred to as a direct virtual image optical system DIS. The imaging optical system IS includes a first lens 30, a first flat plate member 40, and a second flat plate member 50. The first lens 30 has a function as a protective glass that protects a display surface 11d of the display element 11. The first flat plate member 40 includes a third lens 44 facing the first lens 30. The first flat plate member 40 guides image light ML emitted from the display element 11 and incident from the third lens 44 to a second lens 53 of the second flat plate member 50. The second flat plate member 50 reflects the image light ML from the first flat plate member 40 toward a pupil position PP or an eye EY by partially returning the image light ML to the first flat plate member 40, and causes external light OL to enter the pupil position PP via the first flat plate member 40. Each of the first lens 30, the third lens 44, the first flat plate member 40, and the second flat plate member 50 has a function as a lens having positive refractive power.

Although detailed description will be omitted, the second virtual image display device 100B includes a second image forming element 11b, a second display unit 20b, and a second circuit member 80b. The second image forming element 11b is similar to the first image forming element 11a, the second display unit 20b is similar to the first display unit 20a, and the second circuit member 80b is similar to the first circuit member 80a.

In the first virtual image display device 100A, the first image forming element 11a is an image-light generating device of a self-luminous type. The first image forming element 11a emits the image light ML to the first flat plate member 40 via the first lens 30. The first image forming element 11a is housed in and supported by a case 71. The first image forming element 11a is, for example, an organic electro-luminescence (EL) display, and forms a color still image or moving image on the two-dimensional display surface 11d. The first image forming element 11a is driven by the first circuit member 80a to perform display operation. The first image forming element 11a is not limited to the organic EL display, and may be replaced with a display device using inorganic EL, an organic LED, an LED array, a laser array, a quantum dot light emission element, or the like. The first image forming element 11a is not limited to the image-light generating device of a self-luminous type, and it may be possible to employ a device including an LCD or other light modulating elements and illuminating the light modulating elements using a light source such as backlight to form an image. As for the first image forming element 11a, it may be possible to use liquid crystal on silicon (LCOS, LCOS is a registered trademark), a digital micro-mirror device, or the like, instead of the LCD. Note that, in the first virtual image display device 100A, an optical device excluding the first circuit member 80a is referred to as an optical unit 100. It can also be said that the optical unit 100 includes a direct virtual image type optical system, and is a portion corresponding to the direct virtual image optical system DIS included in the first virtual image display device 100A.

The first display unit 20a includes the first lens 30, the first flat plate member 40, a polarized light separation film 45A as an oblique mirror portion 45, and the second flat plate member 50. In the first display unit 20a, the first lens 30 has positive refractive power, and the image light ML from the first image forming element 11a is incident thereon. The first lens 30 includes a light incident surface 30f being a flat surface joined to the first image forming element 11a, and a light emission surface 30g being a convex surface. The light emission surface 30g is, for example, a spherical surface, but may be an aspherical surface having an axially symmetric shape. It can be considered that the first lens 30 is divided into a parallel flat plate 31 and a lens portion 32. By ensuring that a thickness of the parallel flat plate 31 is equal to or greater than a predetermined value, foreign matter adhering to a front surface of the first lens 30 becomes less noticeable. The lens portion 32 is a plano-convex lens having positive refractive power. In the plano-convex lens, one surface has a flat surface shape and another surface has a convex surface shape. The first lens 30 is made of fused quartz, for example, and has a relatively low refractive index.

The first flat plate member 40 includes the third lens 44 which is a plano-convex lens, a parallel flat plate-shaped first prism 41, and a second prism 42 having a parallel flat plate shape. The third lens 44 and the first prism 41 are joined at inclined surfaces 44b and 41a. The first prism 41 and the second prism 42 are joined at the inclined surfaces 41d and 42d. What is obtained by joining the third lens 44, the first prism 41, and the second prism 42 is referred to as a prism light guide member 48. The prism light guide member 48 has an appearance of a parallel flat plate. At the inclined surface 41d formed on a lower side of the first prism 41, the polarized light separation film 45A as the oblique mirror portion 45 being a flat surface is formed. A combination of the prism light guide member 48 and the second flat plate member 50 described later corresponds to the first combiner 103a in FIG. 1.

The third lens 44 is a plano-convex lens having a positive refractive index, and includes an incident optical surface 44a facing the light emission surface 30g of the first lens 30, and the inclined surface 44b joined to the first prism 41. The incident optical surface 44a is a convex surface, for example a spherical surface, but may also be an axially symmetric aspherical surface. The third lens 44 is made of fused quartz, for example, and has a relatively low refractive index. The third lens 44 has a refractive index equivalent to that of the first lens 30.

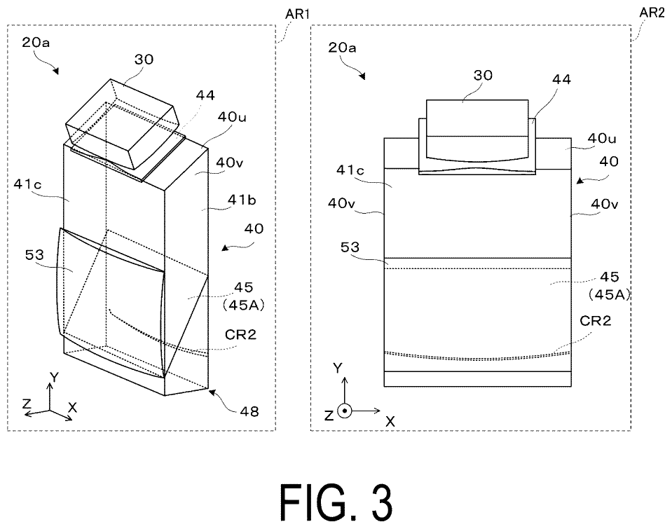

The first prism 41 has a square columnar outer shape, and a trapezoidal vertical cross section. The first prism 41 guides the image light ML, and includes the inclined surface 41a coupled to the inclined surface 44b of the third lens 44, an inner surface 41b, an outer surface 41c, and the inclined surface 41d. Further, the first prism 41 includes an upper flat surface 40u, and a part of a lateral flat surface 40v, which will be described later (see FIG. 3 and the like). Here, the inclined surface 41a is inclined downward on a front side as a whole, and an optical axis passing through the inclined surface 41a extends in a direction between the +Z direction which is a frontward direction and the +Y direction which is an upward direction. Accordingly, the first image forming element 11a which is the display element 11 can be easily disposed closer to an external world side than the inner surface 41b, and it is possible to adjust an angle at which the image light ML propagates in the first prism 41 (in the first prism 41, or inside the first prism 41). The inner surface 41b and the outer surface 41c are parallel to each other, and extend perpendicularly to an optical axis AX between the pupil position PP and the surfaces 41b and 41c. The inner surface 41b and the outer surface 41c internally reflect the image light ML (that is, reflect the image light ML on an inner side of an object surface), but particularly desirably totally reflect the image light ML. By applying a hard coat to the inner surface 41b, scratch resistance or abrasion resistance can be enhanced. The inclined surface 41d is a flat surface. The inclined surface 41d forms an acute angle with respect to the outer surface 41c, to be specific, forms an angle of 25° to 32°. Note that an interval between the optical axis AX passing through the pupil position PP, and the first lens 30 is about 20 mm. The first prism 41 is formed of glass or a resin material, and has a refractive index higher than a refractive index of the first lens 30.

The number of reflections of the image light ML in the first prism 41 is basically one on the inner surface 41b, one on the outer surface 41c, and further one on the polarized light separation film 45A to be described later. By setting the number of internal reflections of the image light ML in the first prism 41 to two, it is possible to avoid mixing of light beams having different numbers of reflections in the first prism 41 while increasing an angle of view of the image light ML, the pupil position PP, or an opening PPa thereof. Since an intermediate image is not formed in the first display unit 20a or the imaging optical system IS, for the image light ML reflected by the inner surface 41b and the outer surface 41c, a degree of divergence is suppressed as compared in an initial divergence state in which the image light ML is emitted from the first image forming element 11a, however, the image light ML is incident on the inner surface 41b and the outer surface 41c in a diverged state, and the diverged state is maintained. Here, the divergence state of the image light ML means a state in which an area occupied by the image light ML on a freely selected virtual plane orthogonal to the optical axis gradually increases as the image light ML advances along the optical axis. In addition, the degree of divergence of the image light ML is suppressed to such a degree that the image light ML is contained inside the first prism 41 at least in a freely selected virtual plane orthogonal to the optical axis, including before and after reflection at the inner surface 41b and the outer surface 41c.

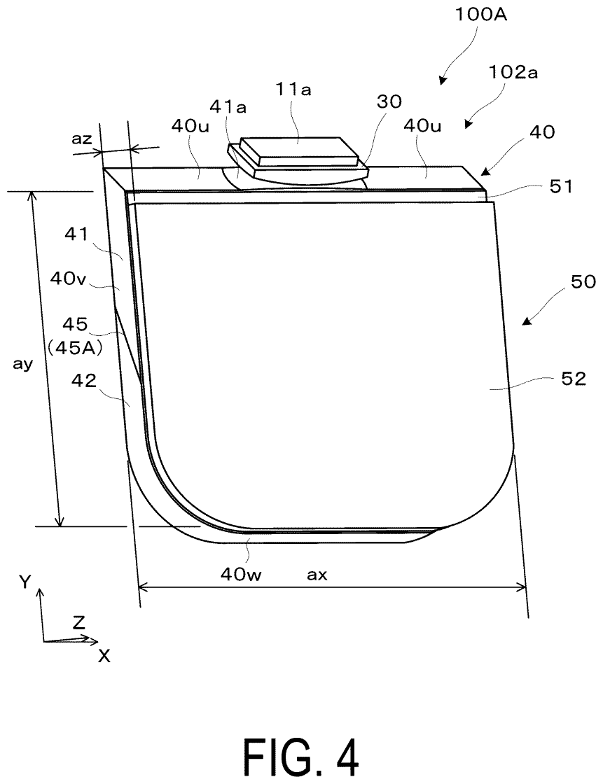

Like the first prism 41, the second prism 42 has a square columnar outer shape, and a trapezoidal vertical cross section. The second prism 42 transmits the image light ML, and includes an inner surface 42b, an outer surface 42c, and the inclined surface 42d. In addition, the second prism 42 includes a part of the lateral flat surface 40v, and a lower flat surface 40w which will be described later (refer to FIGS. 3 and 4). Here, the inner surface 42b and the outer surface 42c are parallel to each other, and extend perpendicularly to the optical axis AX between the pupil position PP and the surfaces 42b and 42c. By applying a hard coat to the inner surface 42b, scratch resistance or abrasion resistance can be enhanced. The second prism 42 is formed of glass or a resin material, and has a refractive index equal to a refractive index of the first prism 41.

The polarized light separation film 45A is integrally formed at the inclined surface 41d of the first prism 41, and is interposed between the inclined surface 41d of the first prism 41 and the inclined surface 42d of the second prism 42. A gap between the polarized light separation film 45A and the inclined surface 42d is filled with an adhesive CT for joining. The polarized light separation film 45A is formed of a dielectric multilayer film, efficiently reflects the image light ML of s-polarized light s when the image light ML includes the s-polarized light s, and efficiently transmits the image light ML of p-polarized light p when the image light ML includes the p-polarized light p. It is sufficient that the polarized light separation film 45A selectively reflects the image light ML in accordance with a polarizing direction, and may be, for example, a wire grid. It is sufficient that the polarized light separation film 45A is a planar surface so as not to affect imaging. In addition, the polarized light separation film 45A may include a slightly curved surface which is convex or concave so as not to affect imaging. Scratch resistance or abrasion resistance of the polarized light separation film 45A can be enhanced by applying a hard coat on a front surface thereof. Note that a gap between the polarized light separation film 45A and the inclined surface 41d may be filled with a filler having transparency instead of the adhesive CT. In this case, a joined state of the first prism 41 and the second prism 42 may be maintained by being supported by a support member or the like from an outside. In addition, the polarized light separation film 45A may be integrally formed at the inclined surface 42d of the second prism 42 instead of the inclined surface 41d of the first prism 41.

When a reflection angle of the image light ML on the optical axis AX in the first prism 41 is β0, an inclination angle θ of the polarized light separation film 45A is equal to or greater than 90°-β0. Assuming that a maximum reflection angle of the image light ML is βmax as a premise that the polarized light separation film 45A does not obstruct a course of the image light ML, it is desirable that the inclination angle θ of the polarized light separation film 45A is smaller than βmax. The reflection angle 30 of the image light ML corresponds to an angle formed by a normal line of the inner surface 41b and the optical axis AX passing through the incident optical surface 44a, and is an acute angle. That is, the optical axis AX of the incident optical surface 44a extends in a direction that forms an angle of less than 90° with respect to the normal line of the inner surface 41b.

The second flat plate member 50 includes a thin plate-like quarter-wave plate 51 and a cover member 52. The quarter-wave plate 51 is made of a crystal or the like having an optical axis between the X direction and the Y direction, turns the image light ML of the s-polarized light s reflected by the polarized light separation film 45A into circularly polarized light c, and turns the image light ML of the circularly polarized light c reflected by the cover member 52 into the p-polarized light p. The cover member 52 includes the plano-convex second lens 53, a plano-concave compensation lens 54, a compensation flat plate 55 provided around the compensation lens 54 and extending parallel to the prism light guide member 48, and a transmission mirror 56.

The second flat plate member 50 is disposed so as to be separated from the first flat plate member 40 by about 20 μm to 50 μm. The outer surfaces 41c and 42c of the first flat plate member 40, and an inner surface 50c of the second flat plate member 50 may be slightly curved, and a minute step may be formed at a boundary between the outer surfaces 41c and 42c, however, by setting an interval between the outer surfaces 41c and 42c and the inner surface 50c to equal to or greater than 20 μm, more desirably equal to or greater than 30 μm, it is possible to prevent these surfaces from being excessively close to each other. On the other hand, by setting the interval between the outer surfaces 41c and 42c, and the inner surface 50c to equal to or less than 50 μm, it is possible to avoid an increase in a thickness of the first combiner 103a in which the first flat plate member 40 and the second flat plate member 50 are combined. Between the outer surfaces 41c and 42c of the first flat plate member 40, and the inner surface 50c of the second flat plate member 50, a spacer 61 is provided for adjusting an interval between the first flat plate member 40 and the second flat plate member 50, and fixing the flat plate members in a mutually positioned state. The spacer 61 is not provided over an entire circumference of the second flat plate member 50. That is, a gap SP between the first flat plate member 40 and the second flat plate member 50 is not sealed, and communicates with the external world.

In the cover member 52, the second lens 53 is thin but has positive refractive power, and includes a flat surface 53f joined to the quarter-wave plate 51, and a convex surface 53g facing the compensation lens 54. The convex surface 53g is, for example a spherical surface, but may be an axially symmetric aspherical surface. The compensation lens 54 is thin but has positive refractive power, and includes a concave surface 54f facing the second lens 53, and a flat surface 54g. The compensation flat plate 55 is a parallel flat plate, and includes a pair of flat surfaces 55f and 55g. Here, the concave surface 54f of the compensation flat plate 55 has the same shape as the convex surface 53g of the second lens 53. The flat surface 54g of the compensation lens 54 and the flat surface 55g of the compensation flat plate 55 are continuous on the same flat surface. The transmission mirror 56 is a thin film formed at the convex surface 53g of the second lens 53, and has the same shape as the convex surface 53g. A combination of the second lens 53 and the transmission mirror 56 is referred to as a first condensing reflection portion CR1.

The second lens 53, the compensation lens 54, and the compensation flat plate 55 are formed of a resin material. The second lens 53, the compensation lens 54, and the compensation flat plate 55 have the same refractive index. The refractive index of the second lens 53 and the like is lower than the refractive index of the first prism 41. The compensation lens 54 and the compensation flat plate 55 are an optical element 58 integrally formed of the same resin material.

A combination of the second lens 53, the compensation lens 54, and the compensation flat plate 55 functions as a parallel flat plate as a whole. That is, the external light OL incident on positions of the compensation lens 54 and the compensation flat plate 55 passes through the positions without being affected by a lens action by the compensation lens 54 and the like or a step present at an outer edge of the compensation lens 54. In this way, the compensation lens 54 optically compensates for influence of the second lens 53 on the external light OL. In this sense, the flat surface 53f of the second lens 53, the flat surface 54g of the compensation lens 54, and the flat surfaces 55f and 55g of the compensation flat plate 55 are not necessarily limited to strictly flat surfaces, and may be, for example, substantially flat surfaces or partially or entirely include curved surfaces. In addition, the flat surface 53f of the second lens 53, the flat surface 54g of the compensation lens 54, and the flat surfaces 55f and 55g of the compensation flat plate 55 may each include a curved surface for correcting visual acuity of the wearer US, or a curved surface designed like sunglasses or lensless glasses as far as inconvenience in terms of optical performances is not caused. The flat surfaces 54g and 55g of the compensation lens 54 and the compensation flat plate 55 may each be provided with an antireflection film or a hard coat. The external light OL passing through the compensation flat plate 55 passes through upper, lower, left, and right sides of the compensation lens 54, and is incident from a peripheral region on an outer side than an incident region of the image light ML corresponding to the compensation lens 54, that is, from the compensation flat plate 55. This makes it possible to ensure a wide see-through field of view with respect to the external world. A visual field range of the external light OL is set to, for example, about 40° in the upper direction and about 40° in a lower direction.

A diameter of the second lens 53 is set to 20 mm to 25 mm from the viewpoint of securing an angle of view. Note that since a thickness of the first flat plate member 40 or the prism light guide member 48 in a Z direction is 6 mm to 8 mm, and a distance from the inner surfaces 41b and 42b of the first flat plate member 40 to the pupil position PP is about 12 mm to 13 mm, the angle of view (diagonal) which is an angle range in which the image light ML is incident on the pupil position PP can be set to about 40°.

The transmission mirror 56 is a half mirror, reflects a part of the image light ML passing through the second lens 53, and transmits a part of the external light OL. The transmission mirror 56 reflects the image light ML reflected by the polarized light separation film 45A of the first flat plate member 40 and passing through the quarter-wave plate 51 and the second lens 53 toward the pupil position PP. The transmission mirror 56 is a concave surface mirror that covers the pupil position PP at which the eye EY or the pupil is disposed, has a concave shape toward the pupil position PP, and has a convex shape toward the external world. The pupil position PP or the opening PPa thereof is referred to as an eye point or an eye box, and corresponds to an exit pupil EP of the first display unit 20a.

The transmission mirror 56 transmits a part of the external light OL, thus see-through view of the external world is enabled, and a virtual image can be superimposed on an external image. At this time, the external light OL passes through the first flat plate member 40 and the second flat plate member 50, but the flat plate members 40 and 50 do not cause a lens action on the external light OL. A reflectance of the transmission mirror 56 with respect to the image light ML and the external light OL is set to equal to or greater than 10% and equal to or less than 50% in a range of an incident angle of the assumed image light ML from the viewpoint of ensuring a luminance of the image light ML and facilitating observation of an external world image by see-through. The transmission mirror 56 is formed of, for example, a dielectric multilayer film configured of a plurality of dielectric layers having an adjusted film thickness. The transmission mirror 56 may be a single-layer film or a multilayer film of metal such as Al or Ag having an adjusted film thickness. The transmission mirror 56 is formed by, for example, lamination using vapor deposition.

FIG. 3 is a conceptual perspective view for mainly explaining the first display unit 20a. In FIG. 3, a region AR1 indicates a state in which the first display unit 20a is viewed in an obliquely upward direction from between +Z which is the frontward direction and +X which is the lateral direction, and a region AR2 indicates a state in which the first display unit 20a is viewed from the +Z side which is the frontward direction. Note that in FIG. 3, the transmission mirror 56 of the second flat plate member 50 is omitted, and only the second lens 53 is illustrated.

In the first virtual image display device 100A, each of the first lens 30, the third lens 44, the second lens 53, and the transmission mirror 56 has positive refractive power, and is caused to have a tendency to converge divergent light. The first lens 30, the third lens 44, the second lens 53, and the transmission mirror 56, including a main body of the first prism 41, the second prism 42, and the like, function as the imaging optical system IS or the direct virtual image optical system DIS like a single-type microscope that forms an erect image. Thus, a real image formed on the display surface 11d of the first image forming element 11a can be formed as a virtual image projected at infinity, for example, or the real image formed on the display surface 11d can be formed as a virtual image projected several meters ahead. At this time, by adjusting refractive power of each of the first lens 30, the third lens 44, the second lens 53, and the transmission mirror 56, it is possible to shorten a focal length of the imaging optical system IS and achieve a desired magnification.

As illustrated in FIG. 2, an optical path along which a part of the image light ML travels after the part is emitted from the display element 11, reflected twice by the inner surface 41b and the outer surface 41c of the first prism 41, reflected by the polarized light separation film 45A as the oblique mirror portion 45, transmitted through the first quarter-wave plate 51 and the second lens 53, reflected by the transmission mirror 56, transmitted through the second lens 53 and the first quarter-wave plate 51 again, transmitted through the polarized light separation film 45A, and travels to reach the exit pupil EP is referred to as a first optical path P1. In addition, a part of the image light ML having predetermined polarization may be referred to as a polarization component of the image light ML or simply as a component.

As illustrated in FIGS. 2 and 3, a second condensing reflection portion CR2 is provided in the prism light guide member 48. The second condensing reflection portion CR2 includes a second quarter-wave plate 21, and a condensing reflection mirror 24. By providing the condensing reflection portion CR2 in the prism light guide member 48, it is possible to emit a part of the image light ML generated by the display element 11, which is transmitted through the polarized light separation film 45A without being reflected by the polarized light separation film 45A, to the exit pupil side while being collimated. As a result, even when two reflection members including the polarized light separation film 45A and the transmission mirror 56 are present in front of the eye, it is possible to increase a utilization efficiency of the image light generated by the display element 11 and increase the luminance of the image light ML.

As illustrated in FIG. 2, an optical path along which a part of the image light ML travels after the part is emitted from the display element 11, reflected twice by the inner surface 41b and the outer surface 41c of the first prism 41, transmitted through the polarized light separation film 45A as the oblique mirror portion 45, reflected by the inner surface 42b of the second prism 42, transmitted through the first quarter-wave plate 21, reflected by the condensing reflection mirror 24, reflected again by the inner surface 42b of the second prism 42, reflected by the polarized light separation film 45A, and travels to reach the exit pupil EP is referred to as a second optical path P2.

Referring to FIG. 4, a size ay in a vertical direction of the first flat plate member 40 or the second flat plate member 50 is, for example, 34 mm, and a size ax in the lateral direction thereof is, for example, 40 mm. A thickness az in a front-rear direction of the first flat plate member 40 is, for example, about 7 mm, and a thickness of a combination of the first flat plate member 40 and the second flat plate member 50 is suppressed to about 7.5 mm. In the first flat plate member 40, upper flat surfaces 40u are provided on the left and right sides of the incident optical surface 44a. Light is not allowed to be incident on the upper flat surface 40u. From the viewpoint of preventing stray lights, a light shielding body (not illustrated) may be disposed at the upper flat surface 40u so as to face the upper flat surface 40u and cover the upper flat surface 40u, or the light shielding body may be applied to the upper flat surface 40u. The lateral flat surface 40v and the lower flat surface 40w may also be provided with light shielding bodies or the like for covering the flat surfaces. A periphery of the second flat plate member 50 can also be provided with a light shielding body or the like covering the periphery.

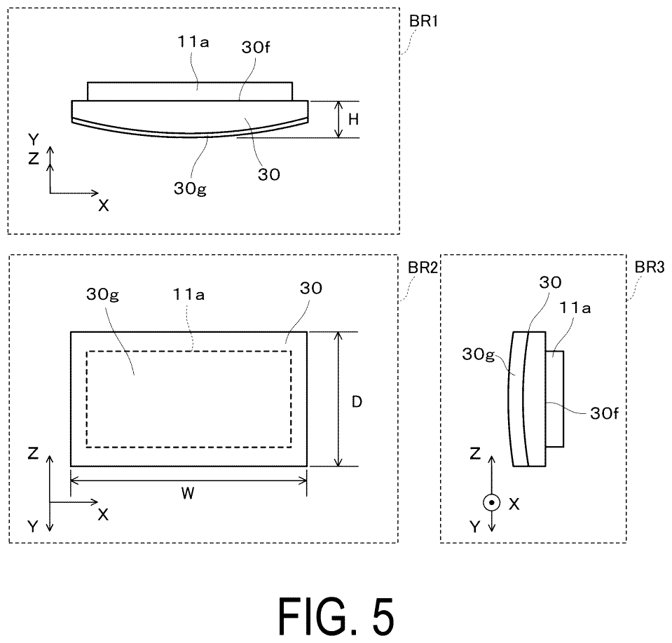

With reference to FIG. 5, shapes or the like of the first image forming element 11a and the first lens 30 will be described. In FIG. 5, a region BR1 illustrates a state in which the first lens 30 and the like are viewed in an obliquely upward direction from the +Z side which is the frontward direction, a region BR2 illustrates a state in which the first lens 30 and the like are viewed in an obliquely forward direction the from −Y side which is a downward direction, and a region BR3 illustrates a state in which the first lens 30 and the like are viewed from the +X side which is the lateral direction. A thickness or height H of the first lens 30 is, for example, about 2 mm, a width W of the first lens 30 is, for example, about 14 mm, and a depth D of the first lens 30 is, for example, about 7 mm.

A curvature radius of the convex light emission surface 30g of the first lens 30 is, for example, 20 mm. In addition, a curvature radius of the incident optical surface 44a of the first prism 41 illustrated in FIG. 2 is, for example, 14 mm, and a curvature radius of the transmission mirror 56 is, for example, 47 mm.

Referring to FIG. 2 for explaining the first optical path P1 which is not affected by the condensing reflection portion CR2 in detail, the image light ML from the first image forming element 11a is incident on the first prism 41 via the first lens 30 and the third lens 44. At this time, a degree of divergence of the image light ML is suppressed by the positive refractive power that the first lens 30 and the third lens 44 have. In an optical path passing through the first prism 41, the image light ML is sequentially reflected by the inner surface 41b of the first prism 41 and the outer surface 41c of the first prism 41 without forming an intermediate image, and a component of the s-polarized light s of the image light ML is reflected by the polarized light separation film 45A. The image light ML of the s-polarized light s reflected by the polarized light separation film 45A is transmitted through the outer surface 41c of the first prism 41, and is transmitted through the first quarter-wave plate 51 included in the second flat plate member 50 to become the circularly polarized light c, and is incident on the transmission mirror 56. A part of the image light ML of the circularly polarized light c incident on the transmission mirror 56 passes through the second lens 53, is reflected by the transmission mirror 56, passes through the second lens 53, and passes through the first quarter-wave plate 51 again in a collimated state. Accordingly, the image light ML passing through the first quarter-wave plate 51 becomes the p-polarized light p, is incident on the first prism 41 from the outer surface 41c, transmitted through the polarized light separation film 45A, and emitted outside the second prism 42 via the inner surface 42b. The image light ML emitted outside the second prism 42 enters the pupil position PP at which the eye EY or pupil of the wearer US is disposed. Not only the image light ML reflected by the transmission mirror 56 but also the external light OL transmitted through the transmission mirror 56, and the external light OL passing through the compensation flat plate 55 enter the pupil position PP. In other words, the wearer US wearing the first virtual image display device 100A can observe a virtual image due to the image light ML in a state of being superimposed on an external world image.

The condensing reflection portion CR2 will be explained with reference to FIGS. 2 and 3. As described above, the condensing reflection portion CR2 includes the second quarter-wave plate 21 and the condensing reflection mirror 24.

Similarly to the first quarter-wave plate 51, the second quarter-wave plate 21 turns the image light ML of the s-polarized light s (or the p-polarized light p) transmitted through the polarized light separation film 45A and reflected by the inner surface 42b of the second prism 42 into the circularly polarized light c, and turns the image light ML of the circularly polarized light c reflected by the condensing reflection mirror 24 into the p-polarized light p (or the s-polarized light s).

The condensing reflection mirror 24 reflects the image light ML passing through the quarter-wave plate 21 and traveling toward the condensing reflection mirror 24 toward the quarter-wave plate 21 while condensing the image light ML on a concave surface 24a which is a reflection surface of the condensing reflection mirror 24.

The condensing reflection mirror 24 is disposed in the prism light guide member 48 so that a length of the first optical path P1 along which the image light ML travels after the image light ML is emitted from the display element 11, and reaches the eye EY via the transmission mirror 56 outside the prism light guide member 48 and a length of the second optical path P2 along which the image light ML travels after the image light ML is emitted from the display element 11, and reaches the eye EY via the condensing reflection mirror 24 in the prism light guide member 48 becomes substantially the same distance. Here, the fact that the lengths of the first optical path P1 and the second optical path P2 are substantially the same is one of conditions under which, in a first component traveling along the first optical path P1 and a second component traveling along the second optical path P2 of the image light ML reaching at the exit pupil EP, positions and sizes of respective pixels of the image light ML are observed to coincide with each other at the exit pupil EP. As long as this condition is satisfied, the lengths of the first optical path P1 and the second optical path P2 need not necessarily be the same. Hereinafter, the length of the first optical path P1 may be referred to as a first optical path length, and the length of the second optical path P2 may be referred to as a second optical path length.

Further, a curvature of the condensing reflection mirror 24 is substantially the same as a curvature of the transmission mirror 56. Further, a material of the second lens 53 is substantially the same as a material of the second prism 42. However, the curvatures and the materials need not necessarily be the same as long as the condition under which the positions and the sizes of the respective pixels of the image light ML are observed to coincide with each other at the exit pupil EP is satisfied. As a result, the image light ML passing through the first optical path P1 and the image light ML passing through the second optical path P2 are brought into a state of overlapping each other when viewed from the eyes EY of the wearer US. At this time, the luminance of the image light ML increases by an amount of the image light ML passing through the second optical path P1, as compared with a luminance when only the image light ML passing through the first optical path P2 is viewed.

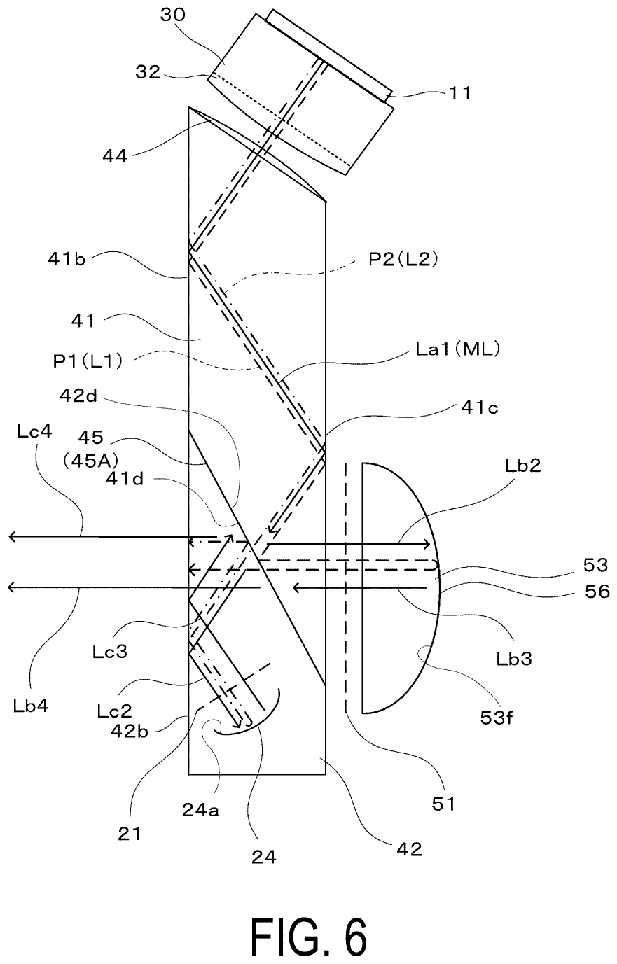

The first optical path P1 and the second optical path P2 will be described in detail with reference to FIG. 6. In FIG. 6, in order to make it easier to distinguish between the optical paths P1 and P2, shapes and dimensions of respective components are schematically illustrated. In addition, in FIG. 6, a length L1 of the first optical path P1 is schematically indicated by a broken line arrow, and a length L2 of the second optical path P2 is schematically indicated by an alternate long and short dash line arrow.

As described above, the first optical path P1 is the optical path along which the image light ML passes after being emitted from the display element 11 as light La1, reflected twice in total by the inner surface 41b and the outer surface 41c of the prism light guide member 48, some components of light La1 are reflected by the polarized light separation film 45A as light Lb2, pass through the first quarter-wave plate 51 and the second lens 53, are reflected by the transmission mirror 56, pass through the second lens 53 and the first quarter-wave plate 51 again as light Lb3, pass through the polarized light separation film 45A, and are emitted from the inner surface 42b of the prism light guide member 48 as light Lb4 to reach the eye EY.

Further, the second optical path P2 is the optical path along which the image light ML passes after being emitted from the display element 11 as the light La1, reflected twice in total by the inner surface 41b and the outer surface 41c of the prism light guide member 48, some components of the light La1 pass through the polarized light separation film 45A as light Lc2, are reflected by the inner surface 42b of the prism light guide member 48, pass through the second quarter-wave plate 21, are reflected by the condensing reflection mirror 24, pass through the second quarter-wave plate 21 again as light Lc3, are reflected by the inner surface 42b of the prism light guide member 48 again, are reflected by the polarized light separation film 45A, and are emitted from the inner surface 42b of the prism light guide member 48 to reach the eye EY as light Lc4.

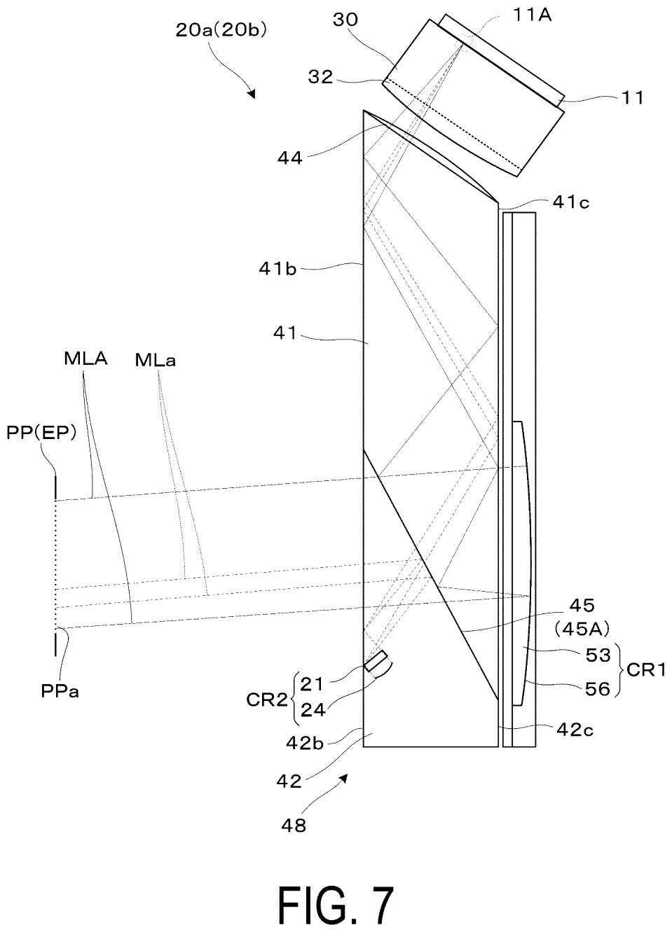

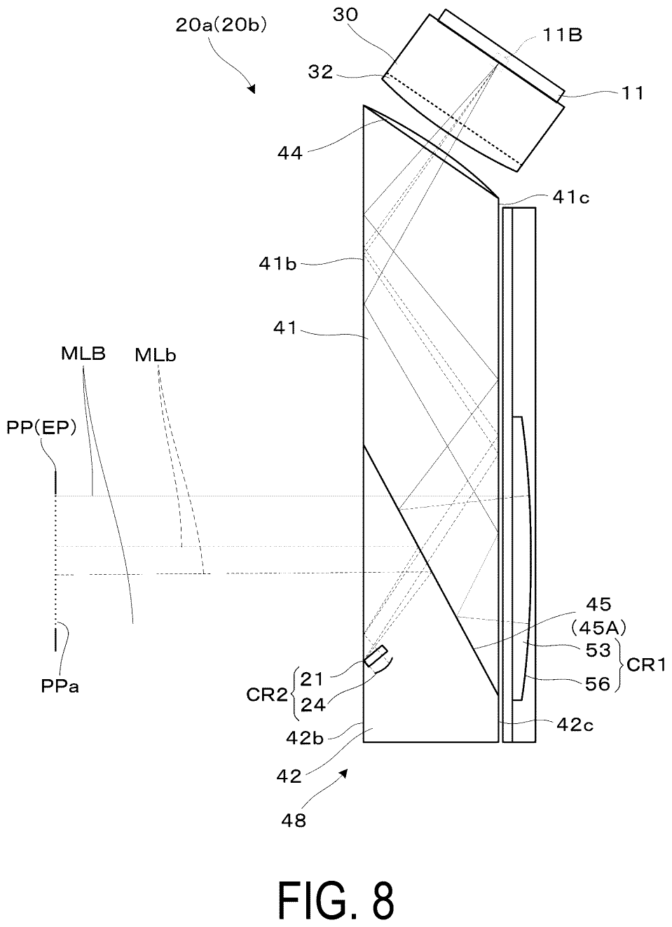

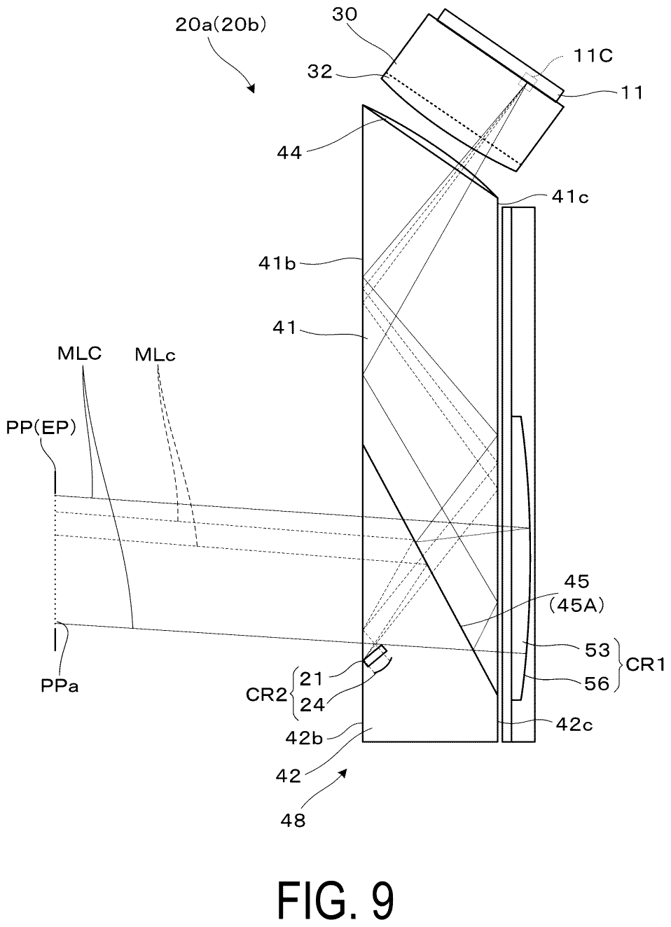

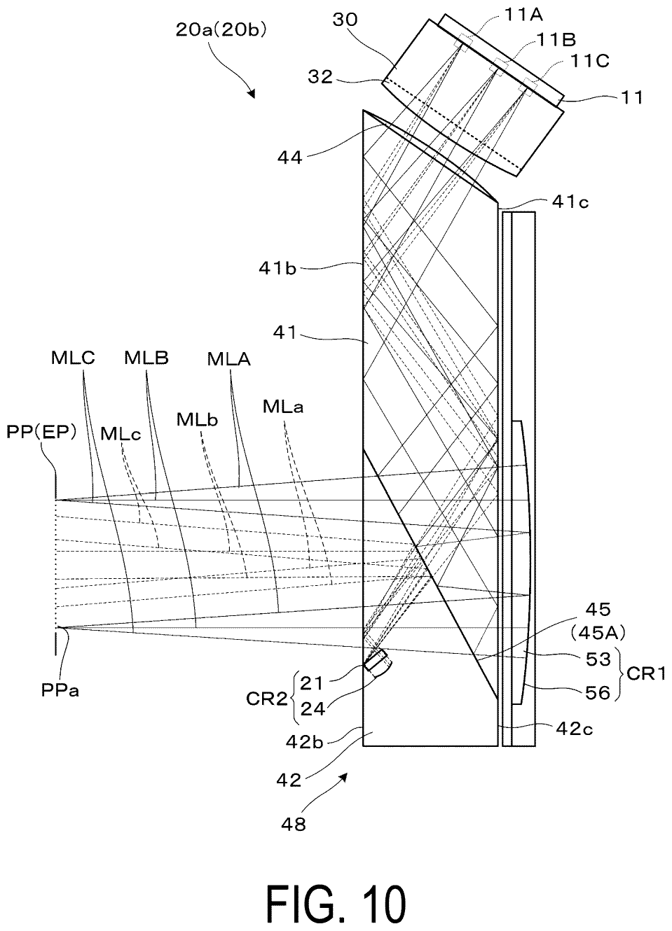

With reference to FIGS. 7, 8, 9, and 10, a result of confirming a state in which a part of the image light ML emitted from the display element 11 is incident on the exit pupil EP by computer simulation will be described. FIG. 7 illustrates a state in which, in the image light ML, a first image light beam MLA emitted from a first display region 11A of the display element 11 and a first partial image light beam MLa included in the first image light beam MLA respectively pass through the first optical path P1 and the second optical path P2 illustrated in FIG. 6, and reach the exit pupil EP as parallel light beams. Similarly, FIG. 8 illustrates a state in which, in the image light ML, a second image light beam MLB emitted from a second display region 11B of the display element 11, and a second partial image light beam MLb included in the second image light beam MLB pass through the first optical path P1 and the second optical path P2 illustrated in FIG. 6, respectively, and reach the exit pupil EP as parallel light beams. Further, FIG. 9 illustrates a state in which, in the image light ML, a third image light beam MLC emitted from a third display region 11C of the display element 11, and a third partial image light beam MLC included in the third image light beam MLC pass through the first optical path P1 and the second optical path P2 illustrated in FIG. 6, respectively, and reach the exit pupil EP as parallel light beams. FIG. 10 illustrates the first image light beam MLA, the first partial image light beam MLa, the second image light beam MLB, the second partial image light beam MLb, the third image light beam MLC, and the third partial image light beam MLC illustrated in FIGS. 7, 8, and 9 in an overlapping manner.

In the examples illustrated in FIGS. 7, 8, 9, and 10, the second partial image light beam MLb emitted from the second display region 11B, which is a central region of the display element 11, passes through a central portion of the exit pupil EP, and the first partial image light beam MLa and the third partial image light beam MLc respectively emitted from the first display region 11A and the third display region 11C, which are peripheral regions of the display element 11, pass through portions off the central portion of the exit pupil EP.

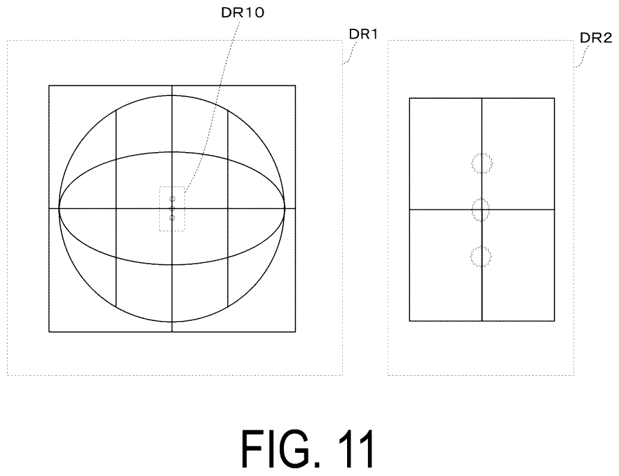

With reference to FIG. 11, a description will be given of a result of confirming, by computer simulation, ray angles at which the first partial image light beam MLa, the second partial image light beam MLb, and the third partial image light beam MLC illustrated in FIG. 10 reach the exit pupil EP. A region DR1 indicates a distribution of luminance of image light observed at the exit pupil EP by angles in logarithmic notation, and a region DR2 illustrates an enlarged view of a central portion DR10 of the region DR1. When the display element 11 emits only the first partial image light beam MLa, the second partial image light beam MLb, and the third partial image light beam MLc, the light beams are incident on only three points illustrated in FIG. 11. From this, it was confirmed that the first partial image light beam MLa, the second partial image light beam MLb, and the third partial image light beam MLc are maintained in parallel similarly to the first image light beam MLA, the second image light beam MLB, and the third image light beam MLC passing through the transmission mirror 56 disposed in front of the eye.

Note that it is also possible to cause all the partial image light beams MLa, MLb, and MLc to pass through a center portion of the exit pupil EP, by taking measures such as increasing a thickness of the prism light guide member 48, or making the condensing reflection mirror 24 larger without changing the thickness of the prism light guide member 48.

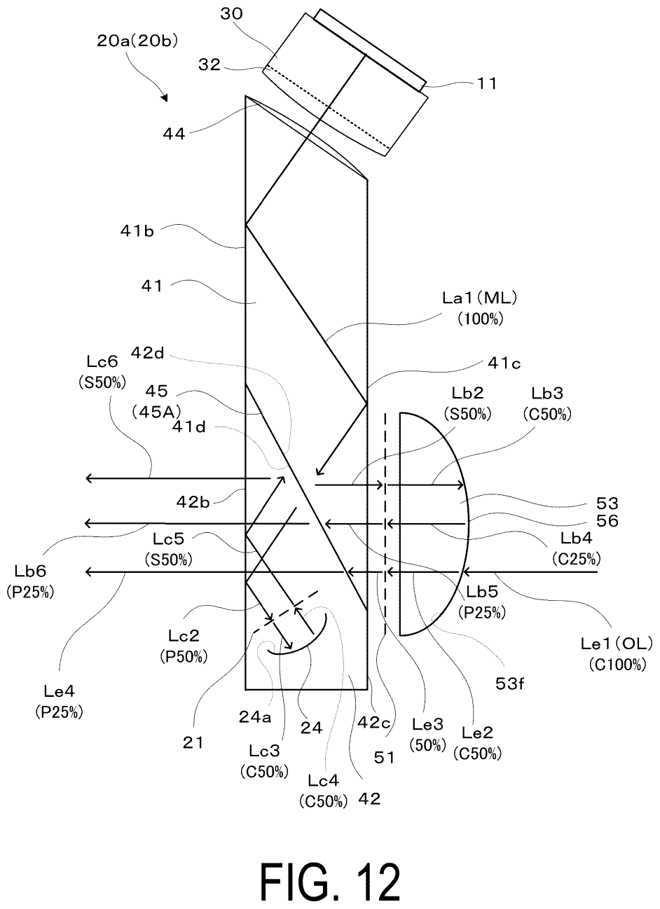

With reference to FIG. 12, a description will be given of a comparison between the present embodiment and two comparative examples regarding utilization efficiency of the image light ML emitted from the display element 11 and see-through transmittance. FIG. 12 illustrates an example of trial calculation results of the utilization efficiency of the image light ML and the see-through transmittance in the present embodiment. In FIG. 12, in order to make it easier to distinguish between the respective optical paths, shapes and dimensions of respective components are schematically illustrated.

In each of the display units 20a and 20b according to the present embodiment illustrated in FIG. 12, the luminance of the image light ML at the time of being emitted from the display element 11 is 100%. The image light ML emitted from the display element 11 is reflected twice by the inner surface 41b and the outer surface 41c of the first prism 41 as the light La1 including the component of the s-polarized light s and the component of the p-polarized light p, and travels toward the polarized light separation film 45A. In the light La1, the component of the s-polarized light s travels along the first optical path P1 described above, is reflected by the polarized light separation film 45A, and travels toward the quarter-wave plate 51 as the light Lb2. Here, a luminance of the light Lb2 is 50% of a luminance of the light La1 immediately before being separated by the polarized light separation film 45A, and is 50% of the luminance of the image light ML at the time of emission. After passing through the quarter-wave plate 51, the light Lb2 travels toward the second lens 53 as the light Lb3 in which the polarization is changed from the s-polarized light s to the right-handed circularly polarized light c. Next, the light Lb3 is reflected by the transmission mirror 56, and travels toward the quarter-wave plate 51 as the light Lb4. Here, when a transmittance and a reflectance of the transmission mirror 56 are 50%, a luminance of the light Lb4 is 50% of a luminance of the light Lb3 immediately before being reflected by the transmission mirror 56, and is 25% of the luminance of the image light ML at the time of emission. In addition, the right-handed circularly polarized light c of the light Lb3 is reflected by the transmission mirror 56 to be changed into the left-handed circularly polarized light c of the light Lb4. Further, after passing through the quarter-wave plate 51 again, the light Lb4 travels toward the polarized light separation film 45A, as light Lb5 in which the polarization is changed from the left-handed circularly polarized light c to the p-polarized light p. Next, the light Lb5 is transmitted through the polarized light separation film 45A, and travels toward the exit pupil EP as light Lb6. Here, a luminance of the light Lb6 is the same as a luminance of the light Lb5 immediately before being transmitted through the polarized light separation film 45A, and is 25% of the luminance of the image light ML at the time of emission.

Further, in the light La1 illustrated in FIG. 12, the component of the p-polarized light p travels along the above-described second optical path P2, is transmitted through the polarized light separation film 45A, reflected by the inner surface 42b of the second prism 42 as the light Lc2, and travels toward the quarter-wave plate 21. Here, a luminance of the light Lc2 is 50% of the luminance of the light La1 immediately before being separated by the polarized light separation film 45A, and is 50% of the luminance of the image light ML at the time of emission. After passing through the quarter-wave plate 21, the light Lc2 travels toward the condensing reflection mirror 24 as the light Lc3 in which the polarization is changed from the p-polarized light p to the right-handed circularly polarized light c. Further, when reflected by the condensing reflection mirror 24, the light Lc3 travels toward the quarter-wave plate 21 as the light Lc4 in which the polarization is changed from the right-handed circularly polarized light c to the left-handed circularly polarized light c. When passing through the quarter-wave plate 21 again, the light Lc4 is reflected by the inner surface 42b of the second prism 42 as light Lc5 in which the polarization is changed from the right-handed circularly polarized light c to the s-polarized light s, and travels toward the polarized light separation film 45A. Here, a luminance of the light Lc5 is the same as the luminance of the light Lc2, and is 50% of the luminance of the image light ML at the time of emission. Next, the light Lc5 is reflected by the polarized light separation film 45A, and travels toward the exit pupil EP as light Lc6. Here, a luminance of the light Lc6 is the same as the luminance of the light Lc5 reflected by the polarized light separation film 45A, and is 50% of the luminance of the image light ML at the time of emission.

Further, as illustrated in FIG. 12, the external light OL enters the second lens 53 from the transmission mirror 56 as light Le1. A luminance of the external light OL immediately before entering the transmission mirror 56 is 100%. However, the luminance of the image light ML at the time of emission does not necessarily coincide with the luminance of the external light OL immediately before the incidence. The light Le1 is transmitted through the transmission mirror 56 and travels toward the quarter-wave plate 51 as light Le2. Here, when the transmittance of the transmission mirror 56 is 50%, a luminance of the light Le2 is 50% of the luminance of the external light OL immediately before the incidence. The light Le1 and the light Le2 include a left-handed circularly polarized light c-component and a right-handed circularly polarized light c-component. After passing through the quarter-wave plate 51, the light Le2 enters the second prism 42 from the outer surface 42c as light Le3, and travels toward the polarized light separation film 45A. The left-handed circularly polarized light c component and the right-handed circularly polarized light c component of the light Le2 pass through the quarter-wave plate 51 to be changed into the component of the s-polarized light s and the component of the p-polarized light p of the light Le3, respectively. In the light Le3, the component of the p-polarized light p is transmitted through the polarized light separation film 45A, and travels toward the exit pupil EP as light Le4. Here, a luminance of the light Le4 is 50% of a luminance of the light Le3 immediately before being transmitted through the polarized light separation film 45A, and is 25% of the luminance of the external light OL immediately before the incidence.

From the above trial calculation, among the light beams reaching the exit pupil EP in FIG. 12, a total of the luminances of the light Lb6 and the light Lc6 derived from the image light ML is 75% of the luminance of the image light ML at the time of emission, and the luminance of the light Le4 derived from the external light OL is 25% of the luminance of the external light OL immediately before the incidence.

A display unit 120 according to a first comparative example corresponds to the display units 20a and 20b according to the present embodiment illustrated in FIG. 12 with the following modifications. That is, the second quarter-wave plate 21 and the condensing reflection mirror 24 are removed, and the polarized light separation film 45A is replaced with a half mirror.

In the display unit 120 according to the first comparative example, the luminance of the image light ML at the time of being emitted from the display element 11 is 100%. The image light ML emitted from the display element 11 is reflected twice by the inner surface 41b and the outer surface 41c of the first prism 41 as the light La1 including the component of the s-polarized light s and the component of the p-polarized light p, and travels toward the half mirror. A part of the light La1 is reflected by the half mirror, travels toward the quarter-wave plate 51 as the light Lb2, and travels toward the transmission mirror 56 as the light Lb3 after passing through the quarter-wave plate 51. Here, when a reflectance of the half mirror is 50%, the luminance of each of the light Lb2 and Lb3 is 50% of the luminance of the light La1 immediately before being reflected by the half mirror, and is 50% of the luminance of the image light ML at the time of emission. Next, the light Lb3 is reflected by the transmission mirror 56, travels toward the quarter-wave plate 51 as the light Lb4, and travels toward the half mirror as the light Lb5 after passing through the quarter-wave plate 51. Here, when the transmittance of the transmission mirror 56 is 50%, the luminance of each of the light Lb4 and Lb5 is 50% of the luminance of the light Lb4 immediately before being reflected by the transmission mirror 56, and is 25% of the luminance of the image light ML at the time of emission. Next, a part of the light Lb5 passes through the half mirror, and travels toward the exit pupil EP as the light Lb6. Here, when a transmittance of the half mirror is 50%, the luminance of the light Lb6 is 50% of the luminance of the light Lb5 immediately before being transmitted through the half mirror, and is 12.5% of the luminance of the image light ML at the time of emission.

Further, in the first comparative example, the external light OL is incident on the second lens 53 from the transmission mirror 56 as the light Le1. The luminance of the external light OL immediately before entering the transmission mirror 56 is 100%. However, the luminance of the image light ML at the time of emission does not necessarily coincide with the luminance of the external light OL immediately before the incidence. The light Le1 is transmitted through the transmission mirror 56 and travels toward the quarter-wave plate 51 as the light Le2. Here, when the transmittance of the transmission mirror 56 is 50%, the luminance of the light Le2 is 50% of the luminance of the external light OL immediately before the incidence. The light Le1 and the light Le2 include the left-handed circularly polarized light c-component and the right-handed circularly polarized light c-component. After passing through the quarter-wave plate 51, the light Le2 is incident on the second prism 42 from the outer surface 42c as the light Le3 and travels toward the half mirror. The left-handed circularly polarized light c component and the right-handed circularly polarized light c component of the light Le2 pass through the quarter-wave plate 51 to be changed into the component of the s-polarized light s and the component of the p-polarized light p of the light Le3, respectively. A part of the component of the s-polarized light s and a part of the component of the p-polarized light p included in the light Le3 are transmitted through the half mirror regardless of a polarizing direction and travel toward the exit pupil EP as the light Le4. Here, when the transmittance of the half mirror is 50%, the luminance of the light Le4 is 50% of the luminance of the light Le3 immediately before being transmitted through the half mirror, and is 25% of the luminance of the external light OL at the time of the incidence.

From the above trial calculation, among the light beams reaching the exit pupil EP in the first comparative example, the luminance of the light Lb6 derived from the image light ML is 12.5% of the luminance of the image light ML at the time of emission, and the luminance of the light Le4 derived from the external light OL is 25% of the luminance of the external light OL immediately before the incidence. When the present embodiment illustrated in FIG. 12 is compared with the first comparative example, the utilization efficiency of the image light ML from the display element 11 according to the present embodiment is six times the utilization efficiency of the image light ML from the display element 11 according to the first comparative example.

A display unit 220 according to a second comparative example corresponds to the display units 20a and 20b according to the present embodiment illustrated in FIG. 12 with the following modifications. That is, the second quarter-wave plate 21 and the condensing reflection mirror 24 are removed, and a polarized light separation film is added between the lens portion 32 of the first lens 30 and the third lens 44 of the first prism 41.

In the display unit 220 according to the second comparative example, the luminance of the image light ML at the time of being emitted from the display element 11 is 100%. The image light ML emitted from the display element 11 travels toward the polarized light separation film as the light La1 including the component of the s-polarized light s and the component of the p-polarized light p. In the light La1, the component of the s-polarized light s is transmitted through the polarized light separation film, reflected twice by the inner surface 41b and the outer surface 41c of the first prism 41, and travels toward the polarized light separation film 45A. Here, in the light La1, a luminance of the component of the s-polarized light s is 50% of the luminance of the light La1 immediately before being transmitted through a polarized light separation film 15, and is 50% of the luminance of the image light ML at the time of emission. Next, in the light La1, the component of the s-polarized light s is reflected by the polarized light separation film 45A, travels toward the quarter-wave plate 51 as the light Lb2, and travels toward the transmission mirror 56 as the light Lb3 passing through the quarter-wave plate 51. Here, the luminance of the light Lb3 is the same as the luminance of the component of the s-polarized light s of the light La1 immediately before being reflected by the polarized light separation film 45A, and is 50% of the luminance of the image light ML at the time of emission. By passing through the quarter-wave plate 51, the s-polarized light s of the light Lb2 is changed into the right-handed circularly polarized light c of the light Lb3. Next, the light Lb3 is reflected by the transmission mirror 56, and travels toward the polarized light separation film 45A as the light Lb4. Here, when the transmittance and the reflectance of the transmission mirror 56 are 50%, the luminance of the light Lb4 is 50% of the luminance of the light Lb3 immediately before being reflected by the transmission mirror 56, and is 25% of the luminance of the image light ML at the time of emission. In addition, the right-handed circularly polarized light c of the light Lb3 is reflected by the transmission mirror 56 to be changed into the left-handed circularly polarized light c of the light Lb4. Further, after passing through the quarter-wave plate 51 again, the light Lb3 travels toward the polarized light separation film 45A, as the light Lb5 in which the polarization is changed from the left-handed circularly polarized light c to the p-polarized light p. Next, the light Lb5 is transmitted through the polarized light separation film 45A, and travels toward the exit pupil EP as the light Lb6. Here, the luminance of the light Lb6 is the same as the luminance of the light Lb5 immediately before being transmitted through the polarized light separation film 45A, and is 25% of the luminance of the image light ML at the time of emission.

Further, in the second comparative example, the external light OL enters the second lens 53 from the transmission mirror 56 as the light Le1, a part of the light Le1 travels toward the quarter-wave plate 51 as the light Le2, travels toward the polarized light separation film 45A as the light Le3 after passing through the quarter-wave plate 51, and a part of the light Le3 is transmitted through the polarized light separation film 45A as the light Le4 to reach the exit pupil EP. Similarly to the case of the light Le4 illustrated in FIG. 12, the luminance of the light Le3 in the first comparative example is 25% of the luminance of the external light OL immediately before the incidence.

From the above trial calculation, among the light beams reaching the exit pupil EP in the second comparative example, the luminance of the light Lb6 derived from the image light ML is 25% of the luminance of the image light ML at the time of emission, and the luminance of the light Le4 derived from the external light OL is 25% of the luminance of the external light OL immediately before the incidence. When the present embodiment illustrated in FIG. 12 is compared with the second comparative example, the utilization efficiency of the image light ML from the display element 11 according to the present embodiment is three times the utilization efficiency of the image light ML from the display element 11 according to the second comparative example.

As described above, according to the present embodiment, in the image light ML emitted from the display element 11, a component which does not reach the exit pupil EP in each comparative example, is caused to reach the exit pupil EP by the second condensing reflection portion CR2 provided inside the second prism 42, and is effectively used, and thus the utilization efficiency of the image light ML from the display element 11 is improved.

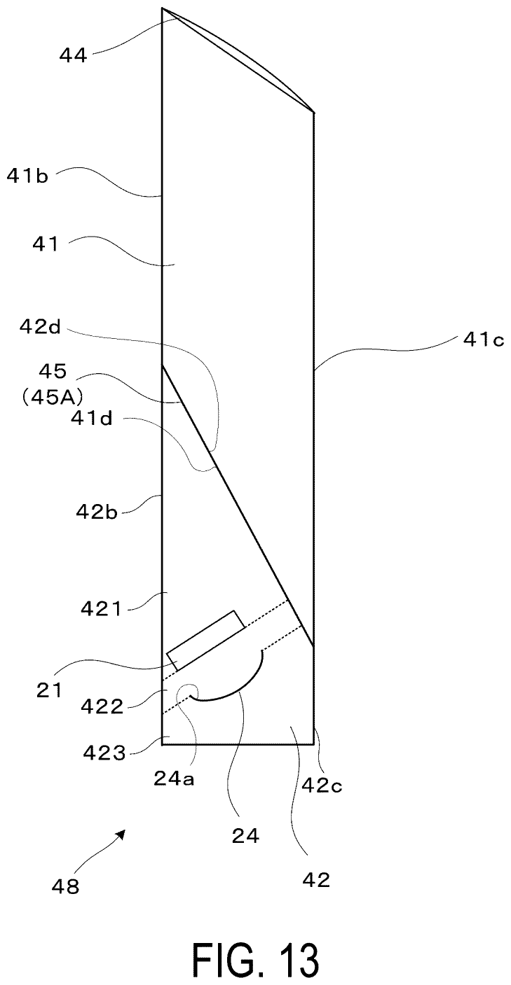

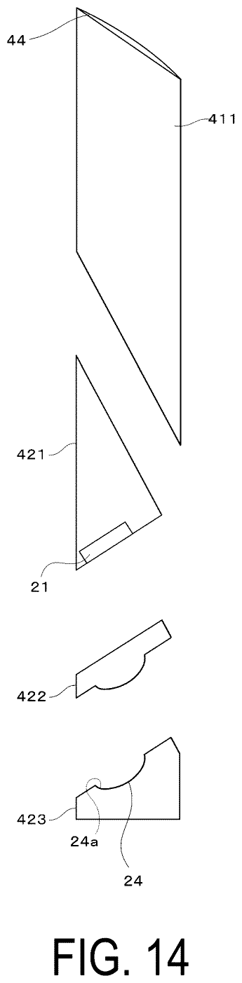

FIG. 13 is a diagram for explaining an example of a structure of the prism light guide member 48. FIG. 14 is a diagram for explaining an example of assembly of the prism light guide member 48. The prism light guide member 48 is formed by joining four components 411, 421, 422, and 423. Note that the number of components included in the prism light guide member 48 is not limited to four, and the number of components can be appropriately changed by changing shapes of the components. The third lens 44 may be joined to the component 411 included in the first prism 41 in advance.

The second prism 42 is a combination of the second component 421 on an upper side, the fourth component 423 on a lower side, and the third component 422 therebetween. The second quarter-wave plate 21 may be joined to the second component 421 in advance. Alternatively, the second quarter-wave plate 21 may be joined to the third component 422 previously. Further, at the fourth component 423, the concave surface 24a of the condensing reflection mirror 24 may be formed in advance. Alternatively, the concave surface 24a of the condensing reflection mirror 24 may be formed at the third component 422 previously. In either case, the first component 411, the second component 421, the third component 422, and the fourth component 423 are joined together to form the prism light guide member 48. The joint of these components may be performed using an adhesive.

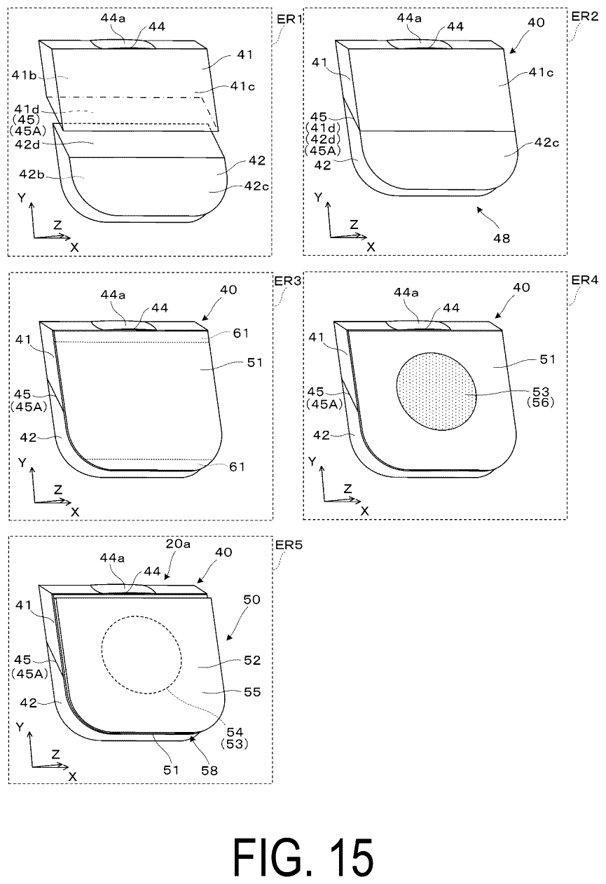

With reference to FIG. 15, an example of a structure and assembly of the first display unit 20a included in the first virtual image display device 100A will be described. In FIG. 15, each of regions ER1 to ER5 is a perspective view for explaining an assembly process of the first display unit 20a. First, as illustrated in the region ER1, the first prism 41 and the second prism 42 are prepared as described above. The first prism 41 and the second prism 42 are made of, for example, glass or resin. The third lens 44 may be joined to the first prism 41 in advance. At the inclined surface 41d of the first prism 41, the polarized light separation film 45A as the oblique mirror portion 45 is formed by vacuum evaporation or another method. As illustrated in the region ER2, the first prism 41 and the second prism 42 are joined to each other at the inclined surfaces 41d and 42d to obtain the prism light guide member 48 or the first flat plate member 40. Next, as illustrated in the region ER3, the quarter-wave plate 51 is affixed to face the outer surfaces 41c and 42c of the first flat plate member 40 illustrated in the regions ER1 and ER2. At this time, spacers 61 which are a pair of thin adhesive agents are disposed between the outer surfaces 41c and 42c of the first flat plate member 40 and the quarter-wave plate 51, and a gap is formed between the outer surfaces 41c and 42c of the first flat plate member 40 and the quarter-wave plate 51. As illustrated in the region ER4, the second lens 53 is affixed to an appropriate position at a front surface of the quarter-wave plate 51. The transmission mirror 56 is formed at a front surface of the second lens 53. Next, as illustrated in the region ER5, the optical element 58 is glued to the quarter-wave plate 51 and the like. At this time, the compensation lens 54 and the second lens 53 of the optical element 58 are positioned, fitted, and joined to each other. In addition, the compensation flat plate 55 and the quarter-wave plate 51 of the optical element 58 are joined to each other. Thus, the assembly of the first display unit 20a is completed.

In the above description, the first display unit 20a is produced so that the second flat plate member 50 is assembled at the first flat plate member 40, however, the first flat plate member 40 and the second flat plate member 50 may be separately assembled, and the first flat plate member 40 and the second flat plate member 50 may be finally joined to each other.

The virtual image display device 100A, 100B, or the optical unit 100 of the first embodiment described above is a virtual image display device or an optical unit of a direct virtual image type that includes the display element 11 configured to emit the image light ML, the first lens 30 on which the image light ML from the display element 11 is incident, the first prism 41 on which the image light ML passing through the first lens 30 is incident, the second prism 42 joined to the first prism 41 and configured to form the parallel flat plate-shaped prism light guide member 48, the polarized light separation film 45A as the oblique mirror portion 45 provided at a joint between the first prism 41 and the second prism 42 and configured to reflect the first part of the image light ML guided in the first prism 41, the plano-convex second lens 53 disposed facing the outer surface 41c of the first prism 41 on which the first part of the image light ML reflected by the oblique mirror portion is incident, the transmission mirror 56 formed at the convex surface 53g of the second lens 53 and configured to reflect a part of the image light ML reflected by the oblique mirror portion 45 toward the oblique mirror portion, the first quarter-wave plate 51 disposed between the outer surface 41c of the first prism 41 and the second lens 53, the compensation lens 54 including the concave surface 54f joined to the convex surface 53g of the second lens 53 via the transmission mirror 56, and the flat surface 55g parallel to the outer surface 41c of the first prism 41, the condensing reflection mirror 24 disposed in the second prism 42 and configured to reflect the second part of the image light ML transmitted through the oblique mirror portion 45 and reflected by the inner surface 42b of the second prism 42, and the second quarter-wave plate 21 disposed between the inner surface 42b of the second prism 42 and the condensing reflection mirror 24.

In the virtual image display devices 100A and 100B or the optical unit 100 described above, a virtual image is directly formed without forming an intermediate image, thus refractive power is ensured by the first lens 30, the second lens 53, and the transmission mirror 56, and it is possible to ensure an enlargement ratio while suppressing an increase in the optical path length and to avoid an increase in the size of the optical system. In addition, even when there are two reflection members in front of the eyes, the utilization efficiency of the image light ML from the display element 11 is improved to increase the luminance of the image light ML at the exit pupil EP by providing the second condensing reflection portion CR2 inside the second prism 42, and a relative luminance of the image light ML with respect to the luminance of the external light OL is also increased.

In the first embodiment described above, the configuration example in which it is assumed that a non-polarizing panel such as an organic EL display is used as the display element 11 has been illustrated. As a modification example of this configuration example, the display element 11 may be a micro LED, a liquid crystal laser backlight, or the like. However, when a light source of the display element 11 emits the image light ML in a state other than a non-polarized state, for example, a quarter-wave plate may be added between the first lens 30 and the third lens 44 so that a desired polarized state is obtained in the polarized light separation film 45A or the like.

In the first embodiment described above, the configuration example in which the reflectance of the condensing reflection mirror 24 is 100% has been illustrated. As a modification example of this configuration example, the condensing reflection mirror 24 may be a half mirror having a reflectance less than 100%, an angle selection film having a reflectance varying depending on an incident angle, or the like. When the angle selection film is used as the condensing reflection mirror 24, a reflectance of the angle selection film may be increased as the incident angle is decreased, as in a case of light incident on the condensing reflection mirror 24 from the front, and the transmittance of the angle selection film may be increased as the incident angle is increased, as in a case of light incident from a small angle with respect to the condensing reflection mirror 24. By using such an angle selection film as the condensing reflection mirror 24, it is possible to achieve both a see-through property of the condensing reflection mirror 24 with respect to the external light OL, and a high utilization efficiency with respect to the image light ML.

### Second Embodiment

Below, a virtual image display device and the like of a second embodiment will be described. Note that the virtual image display device of the second embodiment is provided by partially modifying the virtual image display device of the first embodiment. Thus, explanation of portions common to the virtual image display device of the first embodiment will not be repeated.

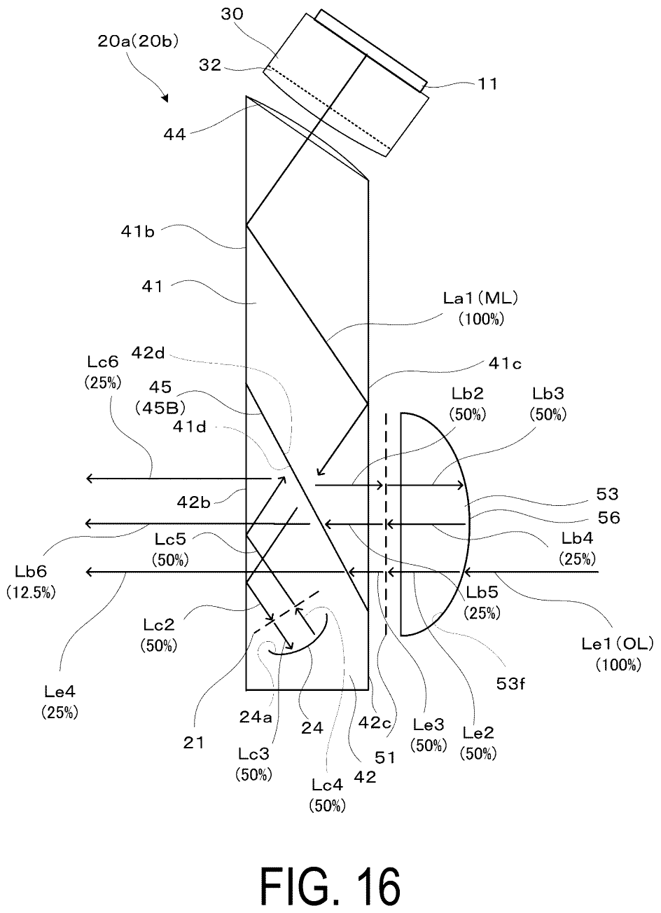

As illustrated in FIG. 16, the virtual image display devices 100A and 100B according to the present embodiment each include a half mirror 45B as the oblique mirror portion 45 instead of the polarized light separation film 45A of the first embodiment. The half mirror 45B reflects a part of the image light ML and a part of the external light OL and partially transmits the image light ML and the external light OL. As an example, a reflectance and a transmittance of the half mirror 45B may be 50%. Hereinafter, the polarized light separation film 45A and the half mirror 45B may be collectively referred to as the oblique mirror portion 45.

The luminance of the image light ML at the time of being emitted from the display element 11 is 100%. The light La1 as the image light ML emitted from the display element 11 is reflected twice by the inner surface 41b of the first prism 41 and the outer surface 41c of the first prism 41, and travels toward the half mirror 45B. A part of the light La1 is reflected by the half mirror 45B, travels toward the quarter-wave plate 51 as the light Lb2, and travels toward the transmission mirror 56 as the light Lb3 after passing through the quarter-wave plate 51. The luminance of each of the light Lb2 and Lb3 is 50% of the luminance of the light La1 immediately before being reflected by the half mirror 45B, and is 50% of the luminance of the image light ML at the time of emission. Next, a part of the light Lb3 is reflected by the transmission mirror 56, travels toward the quarter-wave plate 51 as the light Lb4, and travels toward the half mirror 45B as the light Lb5 passing through the quarter-wave plate 51. When the reflectance of the transmission mirror 56 is 50%, the luminance of each of the light Lb4 and Lb5 is 50% of the luminance of the light Lb3 immediately before being reflected by the transmission mirror 56, and is 25% of the luminance of the image light ML at the time of emission. Next, a part of the light Lb5 passes through the half mirror 45B, and travels toward the exit pupil EP as the light Lb6. The luminance of the light Lb6 is 50% of the luminance of the light Lb5 immediately before being transmitted through the half mirror 45B, and is 12.5% of the luminance of the image light ML at the time of emission.

Additionally, another part of the light La1 as the image light ML emitted from the display element 11 is transmitted through the half mirror 45B, travels toward the quarter-wave plate 21 as the light Lc2, and travels toward the condensing reflection mirror 24 as the light Lc3 passing through the quarter-wave plate 21. The luminance of the light Lc2 and a luminance of the light Lc3 are 50% of the luminance of the light La1 immediately before being transmitted through the half mirror 45B, and is 50% of the luminance of the image light ML at the time of emission. Next, the light Lc3 is reflected by the condensing reflection mirror 24, travels toward the quarter-wave plate 21 as the light Lc4, and travels toward the half mirror 45B as the light Lc5 passing through the quarter-wave plate 21. A luminance of the light Lc4 and the luminance of the light Lc5 are the same as a luminance of the light Lc3 immediately before being reflected by the condensing reflection mirror 24, and are 50% of the luminance of the image light ML at the time of emission. Next, a part of the light Lc5 is reflected by the half mirror 45B, and travels toward the exit pupil EP as the light Lc6. The luminance of the light Lc6 is 50% of the luminance of the light Lc5 immediately before being reflected by the half mirror 45B, and is 25% of the luminance of the image light ML at the time of emission.

Further, the external light OL is incident on the second lens 53 from the transmission mirror 56 as the light Le1. The luminance of the external light OL immediately before entering the transmission mirror 56 is 100%. However, the luminance of the image light ML at the time of emission does not necessarily coincide with the luminance of the external light OL immediately before the incidence. Next, the light Le1 is transmitted through the transmission mirror 56, travels toward the quarter-wave plate 51 as the light Le2, and travels toward the half mirror 45B as the light Le3 passing through the quarter-wave plate 51. When the transmittance of the transmission mirror 56 is 50%, the luminance of each of the light Le2 and Le3 is 50% of a luminance of the light Le1 immediately before being transmitted through the transmission mirror 56, and is 50% of the luminance of the external light OL immediately before the incidence. Next, a part of the light Le3 passes through the half mirror 45B, and travels toward the exit pupil EP as the light Le4. The luminance of the light Le4 is 50% of the luminance of the light Le3 immediately before being transmitted through the half mirror 45B, and is 25% of the luminance of the external light OL immediately before the incidence.

From the above trial calculation, among the light beams reaching the exit pupil EP in FIG. 16, the total of the luminances of the light Lb6 and the light Lc6 derived from the image light ML is 37.5% of the luminance of the image light ML at the time of emission, and the luminance of the light Le4 derived from the external light OL is 25% of the luminance of the external light OL immediately before the incidence.

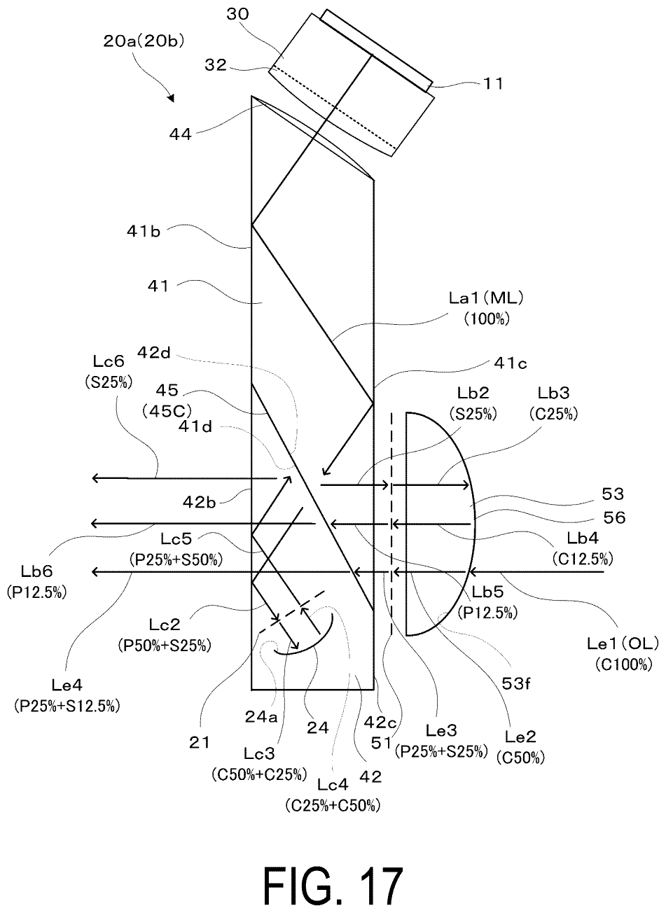

FIG. 17 illustrates another configuration example of the virtual image display devices 100A and 100B according to the present embodiment illustrated in FIG. 16. The virtual image display devices 100A and 100B illustrated in FIG. 17 correspond to the virtual image display devices 100A and 100B illustrated in FIG. 16 with the following modifications. That is, a polarized light separation film 45C is provided as the oblique mirror portion 45 instead of the half mirror 45B. The polarized light separation film 45C reflects 50% of the component of the s-polarized light s included in the incident light and transmits remaining 50%. Further, the polarized light separation film 45C transmits the component of the p-polarized light p included in the incident light.

The luminance of the image light ML at the time of being emitted from the display element 11 is 100%. The light La1 as the image light ML emitted from the display element 11 is reflected twice by the inner surface 41b of the first prism 41 and the outer surface 41c of the first prism 41, and travels toward the polarized light separation film 45C. A part of the component of the s-polarized light s in the light La1 is reflected by the polarized light separation film 45C, and travels toward the quarter-wave plate 51 as the light Lb2. The polarization of the light Lb2 is the s-polarized light s, and the luminance of the light Lb2 is 50% of the luminance of the component of the s-polarized light s included in the light La1 immediately before being reflected by the polarized light separation film 45C, and is 25% of the luminance of the image light ML at the time of emission. After passing through the quarter-wave plate 51, the light Lb2 travels toward the transmission mirror 56 as the light Lb3 in which the polarization is changed from the s-polarized light s to the circularly polarized light c. Next, a part of the light Lb3 is reflected by the transmission mirror 56, and travels toward the quarter-wave plate 51 as the light Lb4. When the reflectance of the transmission mirror 56 is 50%, the luminance of the light Lb4 is 50% of the luminance of the light Lb3 immediately before being reflected by the transmission mirror 56, and is 12.5% of the luminance of the image light ML at the time of emission. Here, after passing through the quarter-wave plate 51, the light Lb4 travels toward the polarized light separation film 45C, as the light Lb5 in which the circularly polarized light c is changed to the p-polarized light p. Next, the light Lb5 is transmitted through the polarized light separation film 45C, and travels toward the exit pupil EP as the light Lb6. The luminance of the light Lb6 is the same as the luminance of the light Lb5 immediately before being transmitted through the polarized light separation film 45C, and is 12.5% of the luminance of the image light ML at the time of emission.

In addition, a part of the component of the s-polarized light s and the component of the p-polarized light p included in the light La1 as the image light ML emitted from the display element 11 are transmitted through the polarized light separation film 45C, and travel toward the quarter-wave plate 21 as the light Lc2. The luminance of the light Lc2 is a sum of 50% of the luminance of the component of the s-polarized light s included in the light La1 immediately before being transmitted through the polarized light separation film 45C, and 100% of a luminance of the component of the p-polarized light p included in the light La1 immediately before being transmitted through the polarized light separation film 45C, and is 75% of the luminance of the image light ML at the time of emission. After passing through the quarter-wave plate 21, the light Lc2 travels toward the condensing reflection mirror 24 as the light Lc3 in which the component of the s-polarized light s, and the component of the p-polarized light p are changed into a component of the right-handed circularly polarized light c and a component of the left-handed circularly polarized light c, respectively. The luminance of the light Lc3 is a sum of a luminance of the component of the right-handed circularly polarized light c and a luminance of the component of the left-handed circularly polarized light c, and is 75% of the luminance of the image light ML at the time of emission. Next, the light Lc3 is reflected by the condensing reflection mirror 24, and travels toward the quarter-wave plate 21 as the light Lc4. By the reflection by the condensing reflection mirror 24, the component of the right-handed circularly polarized light c included in the light Lc3 is changed to the component of the left-handed circularly polarized light c included in the light Lc4, and the component of the left-handed circularly polarized light c included in the light Lc3 is changed to the component of the right-handed circularly polarized light c included in the light Lc4. The luminance of the light Lc4 is a sum of the luminance of the component of the left-handed circularly polarized light c and the luminance of the component of the right-handed circularly polarized light c, and is 75% of the luminance of the image light ML at the time of emission. The light Lc5 after the light Lc4 passes through the quarter-wave plate 21 includes the component of the p-polarized light p to which the component of the left-handed circularly polarized light c of the light Lc4 is changed, and the component of the s-polarized light s to which the component of the right-handed circularly polarized light c of the light Lc4 is changed. Therefore, the luminances of the components of the p-polarized light p and the s-polarized light s included in the light Lc5 after passing through the quarter-wave plate 21 are 25% and 50% of the luminance of the image light ML at the time of emission, respectively. Next, a part of the component of the s-polarized light s included in the light Lc5 is reflected by the polarized light separation film 45C, and travels toward the exit pupil EP as the light Lc6. The luminance of the light Lc6 is 50% of the luminance of the component of the s-polarized light s included in the light Lc5 immediately before being reflected by the polarized light separation film 45C, and is 25% of the luminance of the image light ML at the time of emission.

Further, the external light OL is incident on the second lens 53 from the transmission mirror 56 as the light Le1. The luminance of the external light OL immediately before entering the transmission mirror 56 is 100%. However, the luminance of the image light ML at the time of emission does not necessarily coincide with the luminance of the external light OL immediately before the incidence. Next, the light Le1 is transmitted through the transmission mirror 56, and travels toward the quarter-wave plate 51 as the light Le2. When the transmittance of the transmission mirror 56 is 50%, the luminance of the light Le2 is 50% of the luminance of the light Le1 immediately before being transmitted through the transmission mirror 56, and is 50% of the luminance of the external light OL immediately before the incidence. The light Le1 and the light Le2 include the left-handed circularly polarized light c-component and the right-handed circularly polarized light c-component. After passing through the quarter-wave plate 51, the light Le2 enters the second prism 42 from the outer surface 42c as the light Le3, and travels toward the polarized light separation film 45C. The left-handed circularly polarized light c component and the right-handed circularly polarized light c component of the light Le2 pass through the quarter-wave plate 51 to be changed into the component of the s-polarized light s and the component of the p-polarized light p of the light Le3, respectively. Next, a part of the component of the s-polarized light s included in the light Le3, and the component of the p-polarized light p included in the light Le3 are transmitted through the polarized light separation film 45C, and travel toward the exit pupil EP as the light Le4. In the light Le4, the component of the p-polarized light p is transmitted through the polarized light separation film 45C, and a part of the component of the s-polarized light s is transmitted through the polarized light separation film 45C. When a transmittance of the polarized light separation film 45C is 100% for the p-polarized light p, and 50% for the s-polarized light s, the luminance of the component of the p-polarized light p in the light Le4 is 25% of the luminance of the external light OL immediately before the incidence, and the luminance of the component of the s-polarized light s is 12.5% of the luminance of the external light OL immediately before the incidence. Further, the luminance of the light Le4 is 75% of the luminance of the light Le3 immediately before being transmitted through the polarized light separation film 45C, and is 37.5% of the luminance of the external light OL immediately before the incidence.

From the above trial calculation, among the light beams reaching the exit pupil EP in FIG. 16, the total of the luminances of the light Lb6 and the light Lc6 derived from the image light ML is 37.5% of the luminance of the image light ML at the time of emission, and the luminance of the light Le4 derived from the external light OL is 37.5% of the luminance of the external light OL immediately before the incidence.

As described above, according to the present embodiment as well, in both of the configuration examples illustrated in FIGS. 16 and 17, in comparison with the two comparative examples compared with FIG. 12, a component of the image light ML emitted from the display element 11 which do not reach the exit pupil EP in each comparative example is caused to reach the exit pupil EP by the second condensing reflection portion CR2 provided inside the second prism 42 and is effectively used, and thus the utilization efficiency of the image light ML from the display element 11 is improved.

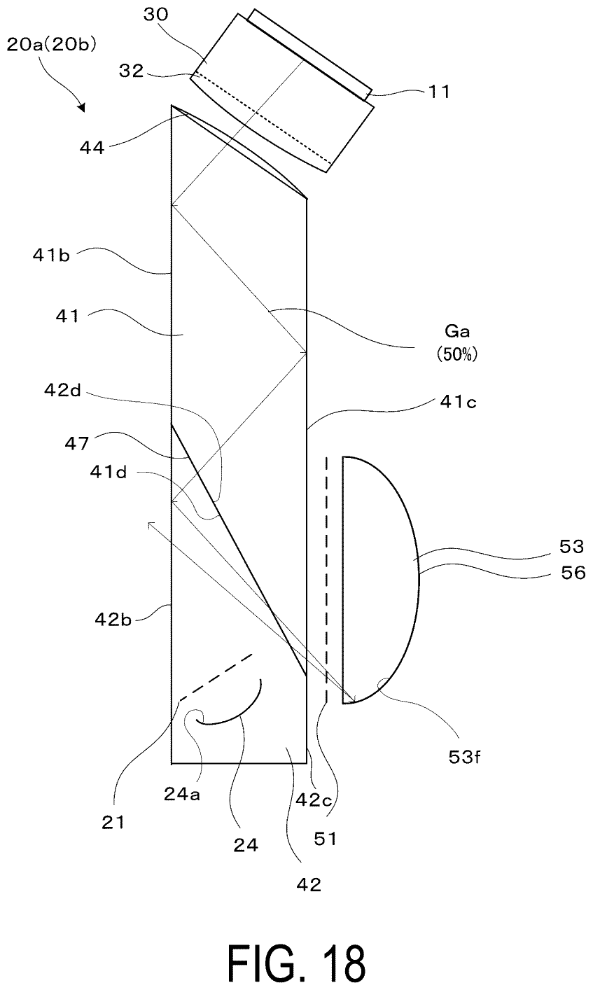

Note that, in the present embodiment, there is a possibility that undesired stray light Ga is generated as a part of the image light ML travels along an optical path illustrated in FIG. 18. In order to suppress the generation of such stray lights Ga, an angle selective mirror having a transmittance varying depending on an incident angle of the incident light may be used, as a part or all of reflection regions included in the half mirror 45B in FIG. 16, the polarized light separation film 45C in FIG. 17, and the transmission mirror 56 in FIGS. 16 and 17. The generation of the stray light Ga can be suppressed by the angle selective mirror not reflecting but transmitting so-called lying light, that is, light having an incident angle larger than a predetermined threshold value. As an example, it is possible to suppress the generation of the stray light derived from the image light, by setting the transmittance of the corresponding reflection region to be higher than a predetermined threshold so that a part of the image light incident on the oblique mirror portion 45 and/or the transmission mirror 56 at an incident angle larger than the predetermined threshold is transmitted without being reflected.

In addition, in the virtual image display devices 100A and 100B according to the present embodiment illustrated in FIGS. 16 and 17, for example, a quarter-wave plate may be added between the first lens 30 and the third lens 44 in accordance with a type of the display element 11 so that a desired polarized state is obtained for the image light ML in the polarized light separation film 45A or the like.

### Third Embodiment

Below, a virtual image display device or the like according to a third embodiment will be described. Note that the virtual image display device according to the third embodiment is provided by partially modifying the virtual image display device according to the first embodiment. Thus, explanation of portions common to the virtual image display device according to the first embodiment will not be repeated.

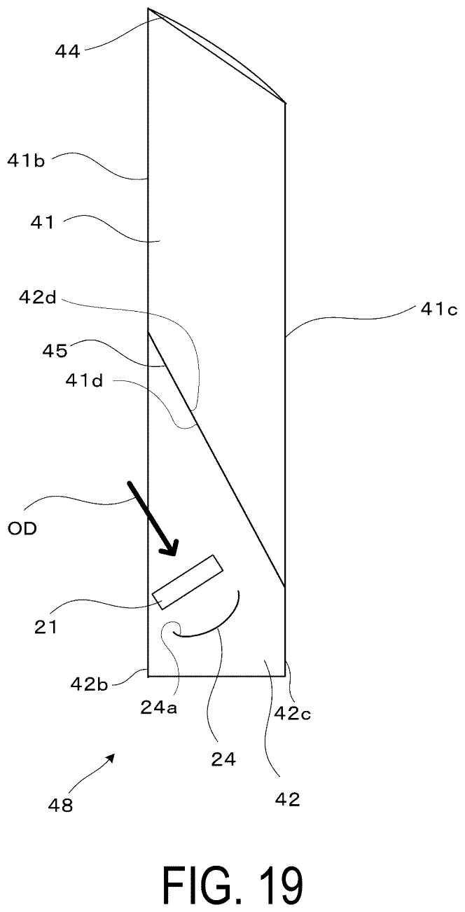

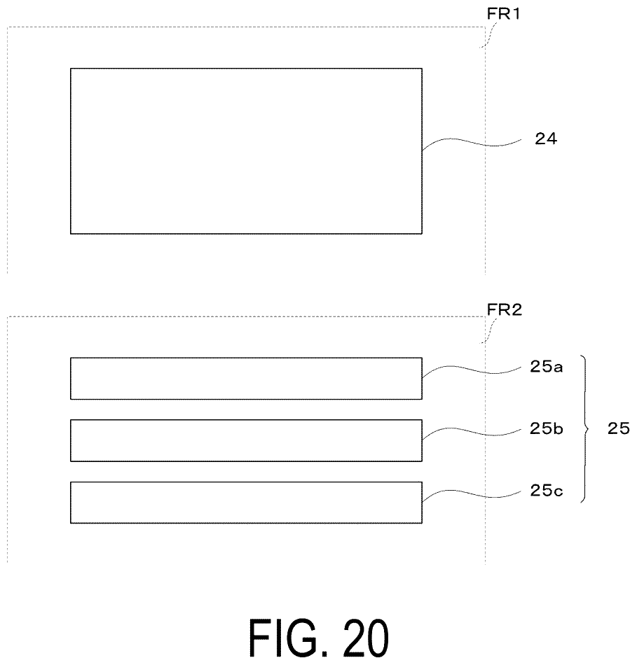

With reference to FIGS. 19 and 20, a description will be given of a case where the condensing reflection mirror 24 of the first embodiment and the second embodiment described above is divided into a plurality of portions. FIG. 20 illustrates a result obtained by observing the condensing reflection mirror 24 in an observation direction OD illustrated in FIG. 19.

A region FR1 in FIG. 20 illustrates a shape of the condensing reflection mirror 24 according to the first embodiment and the second embodiment. The condensing reflection mirror 24 in FIG. 19 is integrated as one concave surface. A region FR2 in FIG. 20 illustrates a shape of a condensing reflection mirror 25 according to the present embodiment. The condensing reflection mirror 25 in FIG. 20 includes a plurality of partial reflection surfaces 25a, 25b, and 25c. The plurality of partial reflection surfaces 25a, 25b, and 25c reflect components of the image light ML transmitted through the polarized light separation film 45A, 45C, or the half mirror 45B as the oblique mirror portion to a plurality of regions included in the exit pupil EP, respectively.

By appropriately dividing the condensing reflection mirror 25 into the plurality of partial reflection surfaces 25a, 25b, and 25c, it is possible to adjust a distribution of the luminance of the image light ML observed in the exit pupil EP to a desired distribution. In addition, it is also possible to reduce luminance unevenness of the image light ML observed in the exit pupil EP by appropriately setting a position and a shape of each of the plurality of partial reflection surfaces 25a, 25b, and 25c. As an example, the luminance of the image light ML observed in the exit pupil EP may be adjusted by selectively disposing the partial reflection surfaces 25a, 25b, and 25c at positions of the exit pupil EP where the image light ML is reflected toward a portion where the luminance of the image light ML is relatively low. Further, a distribution of reflectance and transmittance in each of the plurality of partial reflection surfaces 25a, 25b, and 25c may be set so as to reduce the luminance unevenness. As an example, the luminance of the image light ML observed in the exit pupil EP may be adjusted by setting a reflectance of a region that reflects the image light ML to be relatively high (or a transmittance to be relatively low) at a position of the exit pupil EP where the image light ML is reflected toward a portion where the luminance of the image light ML is relatively low among the partial reflection surfaces 25a, 25b, and 25c. Additionally, the luminance of the image light ML observed in the exit pupil EP may be adjusted by setting the reflectance of the region that reflects the image light ML to be low (or the transmittance to be high) at a position of the exit pupil EP where the image light ML is reflected toward a portion where the luminance of the image light ML is relatively high among the partial reflection surfaces 25a, 25b, and 25c. Additionally, a position of each of the plurality of partial reflection surfaces 25a, 25b, and 25c in the second prism 42 may be finely adjusted in the observation direction OD. As described above, the positions, shapes, reflectances, and transmittances of the plurality of partial reflection surfaces 25a, 25b, and 25c of the condensing reflection mirror 25 may be appropriately set in accordance with a luminance distribution when the first part of the image light ML traveling along the first optical path P1 reaches the inner surface 42b of the second prism 42 so as to reduce the luminance unevenness when the first part of the image light ML traveling along the first optical path P1 and the second part traveling along the second optical path P2 reach the inner surface 42b of the second prism 42.

As described above, replacing the condensing reflection mirror 24 with the condensing reflection mirror 25 including the plurality of partial reflection surfaces 25a, 25b, and 25c enables adjustment of the luminance, reduction of the luminance unevenness, and the like.

### Fourth Embodiment

A virtual image display device and the like of a fourth embodiment will be described below. The virtual image display device according to the fourth embodiment is obtained by partially modifying the virtual image display device according to the first embodiment, and description of parts in common with those of the virtual image display device according to the first embodiment is omitted.

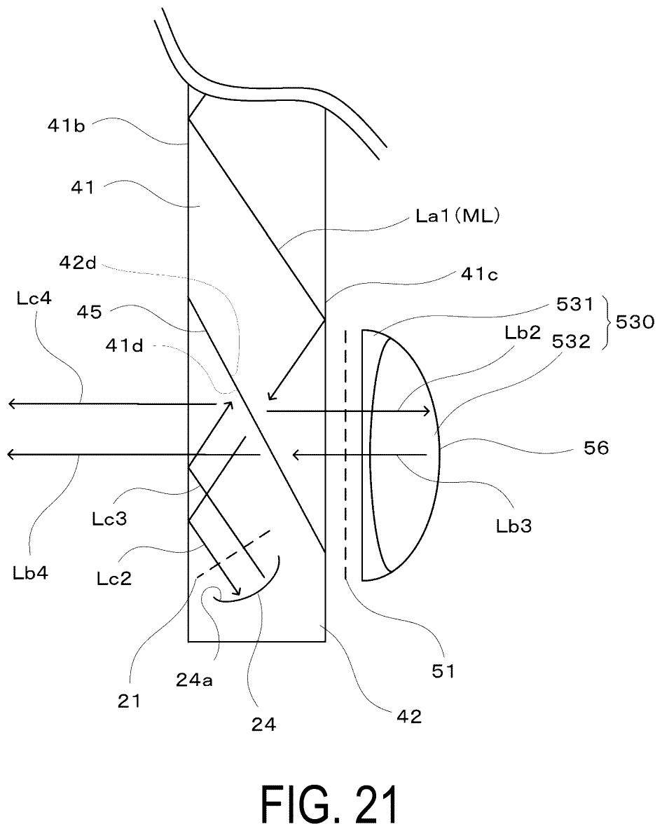

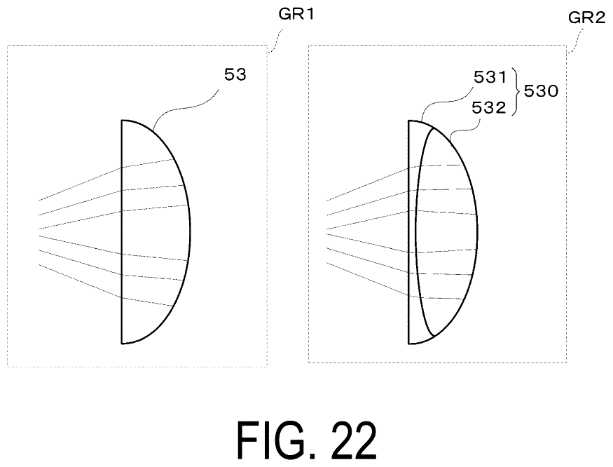

Referring to FIGS. 21 and 22, it will be described that chromatic aberration can be corrected by changing the second lens 53 in the first embodiment and the second embodiment described above to a lens group made of a plurality of materials. In a region GR1 in FIG. 22, an optical path of light incident on the second lens 53 in the first embodiment and the second embodiment is illustrated. A region GR2 in FIG. 22 illustrates an optical path of light incident on a second lens 530 according to the present embodiment.

As illustrated in FIG. 21, the second lens 530 according to the present embodiment includes a first partial lens 531 and a second partial lens 532. The first partial lens 531 is disposed at a position facing the first quarter-wave plate 51. The second partial lens 532 is disposed between the first partial lens 531 and the transmission mirror 56. The first partial lens 531, the second partial lens 532, and the transmission mirror 56 may be integrated. In this case, the first partial lens 531 may be a plano-concave lens including a flat surface and a concave surface, the second partial lens 532 may be a convex lens including two convex surfaces, and the concave surface of the first partial lens 531 and the convex surface on one side of the second partial lens 532 may be complementary to each other. A shape obtained by joining the first partial lens 531 and the second partial lens 532 according to the present embodiment may be the same as the shape of the second lens 53 according to the first embodiment and the second embodiment.

As illustrated in FIG. 22, by appropriately selecting materials of the first partial lens 531 and the second partial lens 532, an optical path in the second lens 530 including the first partial lens 531 and the second partial lens 532 can be changed from that in the second lens 53 made of a single material, and as a result, chromatic aberration can be corrected without changing an optical path length. However, from the viewpoint of making the first optical path length and the second optical path length substantially the same, the material of the second partial lens 532 may be the same as the material of the second prism 42.

### Modification Examples and Others

These are descriptions of the present disclosure with reference to the embodiments. However, the present disclosure is not limited to the embodiments described above. It is possible to implement the present disclosure in various modes without departing from the spirit of the disclosure. For example, the following modifications are possible.

Although the HMD 200 includes the first virtual image display device 100A and the second virtual image display device 100B in the above description, the HMD 200 may be configured such that the single first virtual image display device 100A or second virtual image display device 100B is supported in front of the eye by the support device 100C.

In the cover member 52, the compensation flat plate 55 can be omitted. In this case, the quarter-wave plate 51 is disposed only in a range of the second lens 53, and the second lens 53 is covered with the compensation lens 54.

In the first flat plate member 40, the third lens 44 may be omitted.

Instead of joining the first prism 41 and the third lens 44, the first prism 41 may be formed by integrating a lens portion corresponding to the third lens 44.

The first lens 30 is not limited to a lens joined to the first image forming element 11a, and may be disposed separately from the first image forming element 11a.

A polarizing plate may be provided between the first lens 30 and the third lens 44 depending on a type of the first image forming element 11a serving as a light source.

The first image forming element 11a may be a scanning-type display device including a laser light source or a scanner mirror.

A half mirror may be used instead of the polarized light separation film 45A.

The virtual image display device in a specific aspect is a virtual image display device of a direct virtual image type that includes a display element configured to emit image light, a first lens on which the image light from the display element is incident, a first prism on which the image light passing through the first lens is incident, a second prism joined to the first prism and configured to form a parallel flat plate-shaped prism light guide member, an oblique mirror portion provided at a joint between the first prism and the second prism and configured to reflect a first part of the image light guided in the first prism, a plano-convex second lens disposed facing an outer surface of the first prism on which the first part of the image light reflected by the oblique mirror portion is incident, a transmission mirror formed at a convex surface of the second lens and configured to reflect a part of the image light reflected by the oblique mirror portion toward the oblique mirror portion, a first quarter-wave plate disposed between the outer surface of the first prism and the second lens, a compensation lens including a concave surface joined to the convex surface of the second lens 53 via the transmission mirror, and a surface parallel to the outer surface of the first prism, a condensing reflection mirror disposed in the second prism and configured to reflect a second part of the image light transmitted through the oblique mirror portion and reflected by an inner surface of the second prism, and a second quarter-wave plate disposed between the inner surface of the second prism and the condensing reflection mirror.

In the virtual image display device described above, a virtual image is directly formed without forming an intermediate image, thus refractive power is ensured by the first lens, the second lens, and the transmission mirror, and it is possible to ensure an enlargement ratio while suppressing an increase in an optical path length and to avoid an increase in a size of an optical system. By providing the condensing reflection mirror and the second quarter-wave plate, in addition to the first part reflected by the oblique mirror portion, the second part transmitted through the oblique mirror portion of the image light emitted from the display element is also caused to reach the exit pupil EP, and can be effectively used. As a result, utilization efficiency of the image light from the display element is improved, and a luminance of the image light reaching the exit pupil can be increased even when two reflecting members such as the oblique mirror portion 45 and the transmission mirror 56 are present in front of the eye.

In the virtual image display device in a specific aspect, the oblique mirror portion includes a polarized light separation film for reflecting the image light in accordance with a polarizing direction, the first lens, the prism light guide member, the polarized light separation film, the second lens, the transmission mirror, and the first quarter-wave plate are included in a single-microscope type imaging optical system that forms an erect image, and the first prism internally reflects the image light twice while diverging the image light. In this case, a distance from the display element to the transmission mirror can be easily shortened, the prism light guide member can be reduced in size, and the display element and the first lens can also be easily reduced in size.

In the virtual image display device in a specific aspect, the condensing reflection mirror is disposed at a position where a length of a first optical path along which the first part of the image light is reflected by the polarized light separation film, reflected by the transmission mirror, transmitted through the polarized light separation film, and reaches the inner surface of the second prism is equal to a length of a second optical path along which the second part of the image light is transmitted through the polarized light separation film, reflected by the condensing reflection mirror, reflected by the polarized light separation film, and reaches the inner surface of the second prism. In this case, the image light traveling along the first optical path and the image light traveling along the second optical path can have the same magnification ratio.

In the virtual image display device in a specific aspect, the second prism and the second lens are formed of substantially the same material, and the condensing reflection mirror, when reflecting the second part of the image light, condenses the second part of the image light with substantially the same curvature as a curvature of the convex surface of the second lens. In this case, the image light traveling along the first optical path and the image light traveling along the second optical path can have the same magnification ratio.

In the virtual image display device in a specific aspect, a part of a reflection region of the oblique mirror portion and the transmission mirror transmits a part of the second part of the image light. In this case, it is possible to limit generation of stray light derived from the image light.

In the virtual image display device in a specific aspect, a transmittance when a part of a reflection surface transmits a part of the second part of the image light varies depending on an incident angle at which the second part of the image light is incident on the part of the reflection surface. In this case, it is possible to suppress generation of stray light derived from the image light, by setting a transmittance of a corresponding reflection region to be higher than a predetermined threshold so that a part of the image light incident on the oblique mirror portion and/or the transmission mirror at an incident angle larger than the predetermined threshold is transmitted without being reflected.

In the virtual image display device in a specific aspect, the condensing reflection mirror includes a plurality of partial reflection surfaces, and the plurality of partial reflection surfaces are disposed so as to reflect the second part of the image light to mutually different regions of the exit pupil, respectively. In this case, it is possible to adjust a distribution of luminance of light derived from the image light in the exit pupil.

In the virtual image display device in a specific aspect, a reflectance of each of the plurality of partial reflection surfaces is set so as to reduce luminance unevenness when the first part and the second part of the image light reach the inner surface of the second prism. In this case, it is possible to reduce unevenness of light derived from the image light in the exit pupil.

In the virtual image display device in a specific aspect, the second lens includes a first partial lens facing the first quarter-wave plate, and a second partial lens disposed between the first partial lens and the transmission mirror, and the second partial lens includes the same material as that of the second prism. In this case, chromatic aberration can be suppressed by appropriately selecting a material of the first partial lens.

In the virtual image display device in a specific aspect, the polarized light separation film reflects a first part of s-polarized light in the image light reaching from the first prism, and transmits a first part that is reflected by the transmission mirror, passes through the first quarter-wave plate, and is returned to become p-polarized light.

In the virtual image display device in a specific aspect, the polarized light separation film transmits a second part of the p-polarized light in the image light reaching from the first prism, and reflects the second part that is reflected by the condensing reflection mirror, and passes through the second quarter-wave plate to become the s-polarized light.

In the virtual image display device in a specific aspect, the first quarter-wave plate is disposed to be separated from the outer surface of the first prism. In this case, it is easy to ensure internal reflection of the image light on the outer surface of the first prism.

The virtual image display device in a specific aspect further includes a compensation flat plate provided around the compensation lens, and extending parallel to the prism light guide member. In this case, external light incident on a periphery of the compensation lens can be observed in the same manner as the external light entering the compensation lens.

An optical unit in a specific aspect is an optical unit of a direct virtual image type that includes a first lens on which image light from a display element for emitting the image light is incident, a first prism on which the image light passing through the first lens is incident, a second prism joined to the first prism and configured to form a parallel flat plate-shaped prism light guide member, an oblique mirror portion provided at a joint between the first prism and the second prism and configured to reflect a first part of the image light guided in the first prism, a plano-convex second lens disposed facing an outer surface of the first prism on which the image light reflected by the oblique mirror portion is incident, a transmission mirror formed at a convex surface of the second lens and configured to reflect a part of the image light reflected by the oblique mirror portion toward the oblique mirror portion, a first quarter-wave plate disposed between the outer surface of the first prism and the second lens, a compensation lens including a concave surface joined to the convex surface of the second lens via the transmission mirror, and a surface parallel to the outer surface of the first prism, a condensing reflection mirror disposed in the second prism and configured to reflect a second part of the image light transmitted through the oblique mirror portion and reflected by an inner surface of the second prism, and a second quarter-wave plate disposed between the inner surface of the second prism and the condensing reflection mirror.

What is claimed is:

1. A virtual image display device of a direct virtual image type, comprising:
a display element configured to emit image light;
a first lens on which the image light from the display element is incident;
a first prism on which the image light passing through the first lens is incident;
a second prism joined to the first prism and configured to form a prism light guide member having a parallel flat plate shape;
an oblique mirror portion provided at a joint between the first prism and the second prism and configured to reflect a first part of the image light guided in the first prism;
a second lens being a plano-convex lens and disposed facing an outer surface of the first prism on which the first part of the image light reflected by the oblique mirror portion is incident;
a transmission mirror formed at a convex surface of the second lens and configured to reflect a part of the image light reflected by the oblique mirror portion toward the oblique mirror portion;
a first quarter-wave plate disposed between the outer surface of the first prism and the second lens;
a compensation lens including a concave surface joined to the convex surface of the second lens via the transmission mirror, and a surface parallel to the outer surface of the first prism;
a condensing reflection mirror disposed in the second prism and configured to reflect a second part of the image light transmitted through the oblique mirror portion and reflected by an inner surface of the second prism; and
a second quarter-wave plate disposed between the inner surface of the second prism and the condensing reflection mirror.

2. The virtual image display device according to claim 1, wherein
the oblique mirror portion includes a polarized light separation film for reflecting the image light in accordance with a polarizing direction,
the first lens, the prism light guide member, the polarized light separation film, the second lens, the transmission mirror, and the first quarter-wave plate are included in a single-microscope type imaging optical system that forms an erect image, and
the first prism internally reflects the image light twice while diverging the image light.

3. The virtual image display device according to claim 2, wherein
the condensing reflection mirror is disposed at a position where
a length of a first optical path along which the first part of the image light is reflected by the polarized light separation film, then reflected by the transmission mirror, transmitted through the polarized light separation film, and reaches the inner surface of the second prism is substantially equal to
a length of a second optical path along which the second part of the image light is transmitted through the polarized light separation film, then reflected by the condensing reflection mirror, reflected by the polarized light separation film, and reaches the inner surface of the second prism.

4. The virtual image display device according to claim 3, wherein
the second prism and the second lens are formed of substantially the same material, and the condensing reflection mirror, when reflecting the second part of the image light, condenses the second part of the image light with substantially the same curvature as a curvature of the convex surface of the second lens.

5. The virtual image display device according to claim 1, wherein
a part of a reflection surface included in the oblique mirror portion and/or the transmission mirror transmits a part of the second part of the image light.

6. The virtual image display device according to claim 5, wherein
a transmittance when the part of the reflection surface transmits the part of the second part of the image light varies depending on an incident angle at which the second part of the image light is incident on the part of the reflection surface.

7. The virtual image display device according to claim 1, wherein
the condensing reflection mirror includes a plurality of partial reflection surfaces, and
the plurality of partial reflection surfaces are disposed so as to reflect the second part of the image light to mutually different regions of an exit pupil, respectively.

8. The virtual image display device according to claim 7, wherein
a reflectance of each of the plurality of partial reflection surfaces is set so as to reduce luminance unevenness when the first part and the second part of the image light reach the inner surface of the second prism in accordance with a luminance distribution when the first part of the image light reaches the inner surface of the second prism.

9. The virtual image display device according to claim 1, wherein
the second lens includes
a first partial lens facing the first quarter-wave plate, and
a second partial lens disposed between the first partial lens and the transmission mirror, and
the second partial lens includes the same material as that of the second prism.

10. The virtual image display device according to claim 2, wherein
the polarized light separation film reflects the first part of s-polarized light in the image light reaching from the first prism, and transmits the first part that is reflected by the transmission mirror, passes through the first quarter-wave plate, and is returned to become p-polarized light.

11. The virtual image display device according to claim 2, wherein
the polarized light separation film transmits the second part of p-polarized light in the image light reaching from the first prism, and reflects the second part that is reflected by the condensing reflection mirror, and passes through the second quarter-wave plate to become s-polarized light.

12. The virtual image display device according to claim 1, wherein
the first quarter-wave plate is disposed to be separated from the outer surface of the first prism.

13. The virtual image display device according to claim 1, further comprising a compensation flat plate provided around the compensation lens, and extending parallel to the prism light guide member.

14. An optical unit of a direct virtual image type, comprising:
a first lens that has positive refractive power, and on which image light from a display element for emitting the image light is incident;
a first prism on which the image light passing through the first lens is incident;
a second prism joined to the first prism and configured to form a prism light guide member having a parallel flat plate shape;
an oblique mirror portion provided at a joint between the first prism and the second prism and configured to reflect a first part of the image light guided in the first prism;
a second lens being a plano-convex lens and disposed facing an outer surface of the first prism on which the first part of the image light reflected by the oblique mirror portion is incident;
a transmission mirror formed at a convex surface of the second lens and configured to reflect a part of the image light reflected by the oblique mirror portion toward the oblique mirror portion;
a first quarter-wave plate disposed between the outer surface of the first prism and the second lens;
a compensation lens including a concave surface joined to the convex surface of the second lens via the transmission mirror, and a surface parallel to the outer surface of the first prism;
a condensing reflection mirror disposed in the second prism and configured to reflect a second part of the image light transmitted through the oblique mirror portion and reflected by an inner surface of the second prism; and
a second quarter-wave plate disposed between the inner surface of the second prism and the condensing reflection mirror.
